(19) United States
(12) Patent Application Publication
(10) Pub. No.: US 2010/0328289 A1
(43) Pub. Date: Dec. 30, 2010

(54) Signal-line driving circuit, display apparatus and electronic apparatus

(75) Inventors: Koichiro Enrin, Nagasaki (JP); Toshio Suzuki, Kanagawa (JP); Nobuhiko Shigyo, Fukuoka (JP); Ken Kitamura, Kanagawa (JP); Takaaki Sugiyama, Kanagawa (JP); Yoshimasa Serizawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/801,121

(22) Filed: May 24, 2010

(30) Foreign Application Priority Data
Jun. 25, 2009 (JP) 2009-151423

(51) Int. Cl. G09G 5/00; G09G 3/36

(52) U.S. Cl. 345/211; 345/87

(57) ABSTRACT

A signal-line driving circuit includes an output buffer section configured to amplify input data for driving signal lines in order to generate a positive-polarity signal voltage as well as a negative-polarity signal voltage and selectively supplying the positive-polarity signal voltage as well as the negative-polarity signal voltage to a signal-line pair composing of a first one of the signal lines and a second one of the signal lines, the output buffer section employs: a positive-polarity operational transconductance amplifier; a negative-polarity operational transconductance amplifier; a first output section; a second output section; and a group of switches.

### BACKGROUND OF THE INVENTION

1. Field of the Invention

The present invention relates to a signal-line driving circuit employed in an active-matrix display apparatus such as a liquid-crystal display apparatus, the display apparatus itself and an electronic apparatus which employs the display apparatus.

2. Description of the Related Art

In an image display apparatus such as a liquid-crystal display apparatus, a number of pixels are laid out to form a pixel matrix and an image is displayed by controlling the light intensity of each of the pixels each serving as a display cell in accordance with information representing the image to be displayed.

In recent years, the development of the liquid-crystal display apparatus and the enhancement of their performance are remarkable. Such a liquid-crystal display apparatus can be used as an image display apparatus employed in an electronic apparatus designed for all fields in which a video signal supplied to the electronic apparatus employing the liquid-crystal display apparatus or a video signal generated in the electronic apparatus is displayed as an image or a video picture.

Typical examples of the electronic apparatus are a television, a portable terminal such as a portable telephone or a PDA (Personal Digital Assistant), a digital camera, a notebook personal computer and a video camera.

FIG. 1 is a block diagram showing a rough configuration of an ordinary liquid-crystal display apparatus 1.

As shown in the block diagram of FIG. 1, the liquid-crystal display apparatus 1 has an effective display section 2 including a transparent insulation base such as a glass substrate on which a plurality of pixels are laid out to form a pixel matrix. Each of the pixels employs a liquid-crystal cell.

The liquid-crystal display apparatus 1 also employs a signal-line driving circuit 3 and a gate-line driving circuit 4. In the block diagram of FIG. 1, the signal-line driving circuit 3 is denoted by reference notation HDRV (Horizontal Driving Circuit) whereas the gate-line driving circuit 4 is denoted by reference notation VDRV (Vertical Driving Circuit). To be more explanatory, the signal-line driving circuit 3 serves as a source driver whereas the gate-line driving circuit 4 serves as a gate driver.

As obvious from the above description, on the effective display section 2, a plurality of pixels'each employing a liquid-crystal cell are laid out to form a pixel matrix.

In addition, signal lines each serving as a column line of the pixel matrix of the effective display section 2 are driven by the signal-line driving circuit 3 whereas gate lines each serving as a row line of the pixel matrix of the effective display section 2 are driven by the gate-line driving circuit 4. In the following description, the gate line is also referred to as a vertical scan line.

In order to prevent liquid-crystal molecules in the liquid-crystal display apparatus 1 from deteriorating, it is necessary to apply an AC (Alternating Current) voltage to each liquid-crystal device (or each liquid-crystal cell) employed in the liquid-crystal display apparatus 1. That is to say, an ordinary liquid-crystal display apparatus 1 adopts the so-called polarity inversion operation method which can be a constant-common driving method or a common inversion driving method. In accordance with the polarity inversion operation method, an AC voltage is applied to the liquid-crystal devices to serve as a voltage common to all the liquid-crystal devices.

To put it in detail, the liquid-crystal device has a pixel electrode and a facing electrode exposed to the pixel electrode. In accordance with the constant-common driving method, while a voltage applied to the facing electrode is being sustained at a constant level, an AC voltage is applied to the pixel electrode. The AC voltage applied to the pixel electrode has a polarity which is changed alternately from the positive polarity relative to the constant-level voltage applied to the facing electrode to the negative polarity relative to the constant-level voltage applied to the facing electrode and vice versa.

In accordance with the common inversion driving method, on the other hand, while a voltage applied to the facing electrode is being changed from a high level to a low one and vice versa repeatedly, a voltage, is applied to the pixel electrode. The voltage applied to the pixel electrode has a polarity which is changed alternately from the positive polarity relative to the voltage applied to the facing electrode to the negative polarity relative to the voltage applied to the facing electrode and vice versa.

To put it in more detail, in accordance with the common inversion driving method, while a voltage applied to the facing electrode is being sustained at the high level, a voltage having the negative polarity relative to the high-level voltage applied to the facing electrode is applied to the pixel electrode. The negative-polarity voltage applied to the pixel electrode is a voltage lower than a reference voltage which is set at the level of the high-level voltage applied to the facing electrode. While a voltage applied to the facing electrode is being sustained at the low level, on the other hand, a voltage having the positive polarity relative to the low-level voltage applied to the facing electrode is applied to the pixel electrode. The positive-polarity voltage applied to the pixel electrode is a voltage higher than a reference voltage which is set at the level of the low-level voltage applied to the facing electrode.

In order to carry out polarity inversion operations based on the polarity inversion operation method, the signal-line driving circuit 3 is configured to employ an output buffer section.

In order for the signal-line driving circuit 3 to carry out the polarity inversion operations, the output buffer section is configured to make use of a rail-to-rail output analog buffer circuit as described in CMOS, Circuit Design, Layout and Simulation, P661, FIGS. 25 and 49 authored by R. Jacob, Baker Harry, W. Li and David E. Boyce or make use of an output selector which has a switch as described in Japanese Patent Laid-Open No. Hei 10-153986.

FIG. 2 is a block diagram showing a typical configuration of the ordinary signal-line driving circuit 3 which is configured to make use of an output selector.

As shown in the figure, the signal-line driving circuit 3 has a line buffer 31 and a level shifter 32. The line buffer 31 is a memory used for storing driving data for driving signal lines. The line buffer 31 serves as a parallel-to-serial converter. The level shifter 32 is a section for converting the level of the driving data read out from the line buffer 31 into a driving level.

In addition, the signal-line driving circuit 3 also has a selector section 33 which includes a plurality of DACs (Digital-to-Analog Converters) each used for converting the digital driving data received from the level shifter 32 into analog data in accordance with a gradation voltage supplied to the selector section 33.

On top of that, the signal-line driving circuit 3 also employs a buffer/amplifier section 34 for amplifying the analog driving data received from the selector section 33 and outputting the amplified driving data as a signal voltage having a positive or negative polarity.

In addition, the signal-line driving circuit 3 also has an output selector 35 for selectively supplying the signal voltages with positive and negative polarities to signal lines which are adjacent to each other.

FIG. 3 is a block diagram showing a typical configuration of the buffer/amplifier section 34 and the output selector 35 which are employed in the signal-line driving circuit 3 shown in the block diagram of FIG. 2.

The buffer/amplifier section 34 and the output selector 35 which are shown in the block diagram of FIG. 3 serve as an output buffer section included in the signal-line driving circuit 3. The output buffer section is an analog output buffer section provided for 2 channels adjacent to each other. In actuality, the number of channels driven by such an analog output buffer is at least 100. Each of the channels corresponds to a signal line driven by the analog output buffer.

The buffer/amplifier section 34 shown in the block diagram of FIG. 3 has a positive-polarity amplifier circuit 34-1 and a negative-polarity amplifier circuit 34-2.

The positive-polarity amplifier circuit 34-1 supplies a signal voltage having the positive polarity to a first signal line SGL1 of a first channel CH1 and a second signal line SGL2 of a second channel CH2. On the other hand, the negative-polarity amplifier circuit 34-2 supplies a signal voltage having the negative polarity to the first signal line SGL1 of the first channel CH1 and the second signal line SGL2 of the second channel CH2.

The positive-polarity amplifier circuit 34-1 is configured to employ a positive-polarity OTA (Operational Transconductance Amplifier) 34-11 and a positive-polarity OAMP (output amplifier) 34-12. The positive-polarity OTA 34-11 is wired to the output node of a DAC employed in the selector section 33 at the preceding stage in accordance with the cascade connection method.

The inverting input node (−) of the positive-polarity OTA 34-11 is connected to the output node of the DAC employed in the selector section 33 provided at the preceding stage whereas the non-inverting input node (+) of the positive-polarity OTA 34-11 is connected to the output node of the positive-polarity OAMP 34-12.

By the same token, the negative-polarity amplifier circuit 34-2 is configured to employ a negative-polarity OTA 34-21 and a negative-polarity OAMP 34-22. The negative-polarity OTA 34-21 is wired to the output node of another DAC employed in the selector section 33 at the preceding stage in accordance with the cascade connection method.

The inverting input node (−) of the negative-polarity OTA 34-21 is connected to the output node of the other DAC employed in the selector 33 provided at the preceding stage whereas the non-inverting input node (+) of the negative-polarity OTA 34-21 is connected to the output node of the negative-polarity OAMP 34-22.

The output selector 35 employs a first switch group 35-1 and a second switch group 35-2.

The first switch group 35-1 has a switch SW11 and a switch SW12. The switch SW11 is put in a turned-on state or a turned-off state by a common switch-state changeover control signal STR complementarily to the switch SW12 whereas the switch SW12 is put in a turned-on state or a turned-off state by a common switch-state changeover control signal CRS complementarily to the switch SW11.

A node a of the switch SW11 is connected to the output node of the positive-polarity OAMP 34-12 employed in the positive-polarity amplifier circuit 34-1 whereas a node b of the switch SW11 is connected to the first signal line SGL1 of the first channel CH1.

A node a of the switch SW12 is connected to the output node of the positive-polarity OAMP 34-12 employed in the positive-polarity amplifier circuit 34-1 whereas a node b of the switch SW12 is connected to the second signal line SGL2 of the second channel CH2.

By the same token, the second switch group 35-2 has a switch SW21 and a switch SW22. The switch SW21 is put in a turned-on state or a turned-off state by the common switch-state changeover control signal STR complementarily to the switch SW22 whereas the switch SW22 is put in a turned-on state or a turned-off state by the common switch-state changeover control signal CRS complementarily to the switch SW21.

A node a of the switch SW21 is connected to the output node of the negative-polarity OAMP 34-22 employed in the negative-polarity amplifier circuit 34-2 whereas a node b of the switch SW21 is connected to the second signal line SGL2 of the second channel CH2.

A node a of the switch SW22 is connected to the output node of the negative-polarity OAMP 34-22 employed in the negative-polarity amplifier circuit 34-2 whereas a node b of the switch SW22 is connected to the first signal line SGL1 of the first channel CH1.

In the configuration described above, when the switches SW11 and SW21 employed in the output selector 35 are controlled to enter a turned-on state, the switches SW12 and SW22 employed in the output selector 35 are controlled to enter a turned-off state.

Thus, a positive-polarity signal voltage generated by the positive-polarity amplifier circuit 34-1 is applied to the first signal line SGL1 whereas a negative-polarity signal voltage generated by the negative-polarity amplifier circuit 34-2 is applied to the second signal line SGL2.

When the switches SW12 and SW22 employed in the output selector 35 are controlled to enter a turned-on state, on the other hand, the switches SW11 and SW21 employed in the output selector 35 are controlled to enter a turned-off state.

Thus, a positive-polarity signal voltage generated by the positive-polarity amplifier circuit 34-1 is applied to the second signal line SGL2 whereas a negative-polarity signal voltage generated by the negative-polarity amplifier circuit 34-2 is applied to the first signal line SGL1.

### SUMMARY OF THE INVENTION

As described above, in order to carry out polarity inversion operations, the output buffer section employed in the liquid-crystal display apparatus is configured to make use of a rail-to-rail output analog buffer circuit or make use of an output selector as shown in the block diagrams of FIGS. 2 and 3.

However, the rail-to-rail output analog buffer circuit raises problems of a complicated circuit configuration, a large power consumption of the circuit and a large size of the layout area of the circuit.

In the case of the output selector, it is possible to prevent the circuit configuration from becoming complicated and the power consumption of the circuit from increasing. However, the use of the output selector raises the following problems.

In order to reduce an ON resistance, the size of the output selector and the size of the output stage must be undesirably increased. As a result, the size of the layout area rises inevitably.

In addition, the ON resistance of the output selector worsens a settling characteristic.

The number of channels for the analog buffer is at least 100. In high-definition applications of the liquid-crystal display apparatus, reduction of the size of the layout area is strongly demanded. In addition, conversions made in recent years from ordinary liquid-crystal display apparatus into high-definition liquid-crystal display apparatus have raised a problem as to how to increase the operating frequency.

Addressing the problems described above, inventors of an embodiment of the present invention have innovated a signal-line driving circuit which can be designed without making the configuration of the circuit complicated, is capable of preventing a current consumed by the circuit from increasing and is capable of preventing the characteristic of the circuit from deteriorating. In addition, the inventors also have innovated an active-matrix display apparatus employing such a signal-line driving circuit and an electronic apparatus having the active-matrix display apparatus.

A signal-line driving circuit according to a first embodiment of the present invention includes an output buffer section configured to amplify input data for driving signal lines in order to generate a positive-polarity signal voltage as well as a negative-polarity signal voltage and selectively supplying the positive-polarity signal voltage as well as the negative-polarity signal voltage to a signal-line pair composing of a first one of the signal lines and a second one of the signal lines. The output buffer section employs: a positive-polarity operational transconductance amplifier configured to amplify the input data in order to generate the positive-polarity signal voltage; a negative-polarity operational transconductance amplifier configured to amplify the input data in order to generate the negative-polarity signal voltage; a first output section configured to supply the positive-polarity signal voltage or the negative-polarity signal voltage to the first signal line; and a second output section configured to supply the positive-polarity signal voltage or the negative-polarity signal voltage to the second signal line. The output buffer section further employs a group of switches which are provided respectively on a forward path between the output node of the positive-polarity operational transconductance amplifier and an input node of the first output section, on a forward path between the output node of the positive-polarity operational transconductance amplifier and an input node of the second output section, on a forward path between the output node of the negative-polarity operational transconductance amplifier and another input node of the second output section, and on a forward path between the output node of the negative-polarity operational transconductance amplifier and another input node of the first output section. The group of switches are further provided respectively on a feedback path between the output node of the first output section and a specific input node of the positive-polarity operational transconductance amplifier, on a feedback path between the output node of the second output section and the specific input node of the positive-polarity operational transconductance amplifier, on a feedback path between the output node of the second output section and a particular input node of the negative-polarity operational transconductance amplifier and on a feedback path between the output node of the first output section and the particular input node of the negative-polarity operational transconductance amplifier. Each of the first output section and the second output section carries out a process on the positive-polarity signal voltage generated by the positive-polarity operational transconductance amplifier and selectively supplied to the first and second output sections by the group of switches in a voltage range between a power-supply voltage and an intermediate reference voltage set between the power-supply voltage and a reference voltage, outputting a result of the process. By the same token, each of the first output section and the second output section carries out another process on the negative-polarity signal voltage generated by the negative-polarity operational transconductance amplifier and selectively supplied to the first and second output sections by the group of switches in another voltage range between the reference voltage and an intermediate power-supply voltage set between the power-supply voltage and the reference voltage, outputting a result of the other process.

A display apparatus according to a second aspect of the present invention includes: a display section on which display cells driven by adoption of a polarity inversion driving method are laid out to form a cell matrix; and a signal-line driving circuit for supplying a positive-polarity signal voltage and a negative-polarity signal voltage to signal lines connected to the display cells in driving operations carried out in conformity with the polarity inversion driving method. The signal line driving circuit has an output buffer section configured to amplify input data for driving the signal lines in order to generate the positive-polarity signal voltage as well as the negative-polarity signal voltage and selectively supplying the positive-polarity signal voltage as well as the negative-polarity signal voltage to a signal-line pair composing of a first one of the signal lines and a second one of the signal lines. The output buffer section employs a positive-polarity operational transconductance amplifier configured to amplify the input data in order to generate the positive-polarity signal voltage, a negative-polarity operational transconductance amplifier configured to amplify the input data in order to generate the negative-polarity signal voltage, a first output section configured to supply the positive-polarity signal voltage or the negative-polarity signal voltage to the first signal line, and a second output section configured to supply the positive-polarity signal voltage or the negative-polarity signal voltage to the second signal line. The output buffer section further employs a group of switches which are provided respectively on a forward path between the output node of the positive-polarity operational transconductance amplifier and an input node of the first output section, on a forward path between the output node of the positive-polarity operational transconductance amplifier and an input node of the second output section, on a forward path between the output node of the negative-polarity operational transconductance amplifier and another input node of the second output section, and on a forward path between the output node of the negative-polarity operational transconductance amplifier and another input node of the first output section. The group of switches are further provided respectively on a feedback path between the output node of the first output section and a specific input node of the positive-polarity operational transconductance amplifier, on a feedback path between the output node of the second output section and the specific input node of the positive-polarity operational transconductance amplifier, on a feedback path between the output node of the second output section and a particular input node of the negative-polarity operational transconductance amplifier and on a feedback path between the output node of the first output section and the particular input node of the negative-polarity operational transconductance amplifier. Each of the first output section and the second output section carries out a process on the positive-polarity signal voltage generated by the positive-polarity operational transconductance amplifier and selectively supplied to the first and second output sections by the group of switches in a voltage range between a power-supply voltage and an intermediate reference voltage set between the power-supply voltage and a reference voltage, outputting a result of the process. By the same token, each of the first output section and the second output section carries out another process on the negative-polarity signal voltage generated by the negative-polarity operational transconductance amplifier and selectively supplied to the first and second output sections by the group of switches in another voltage range between the reference voltage and an intermediate power-supply voltage set between the power-supply voltage and the reference voltage, outputting a result of the other process.

An electronic apparatus according to a third embodiment of the present invention has a display apparatus which includes: a display section on which display cells driven by adoption of a polarity inversion driving method are laid out to form a cell matrix; and a signal-line driving circuit for supplying a positive-polarity signal voltage and a negative-polarity signal voltage to signal lines connected to the display cells in driving operations carried out in conformity with the polarity inversion driving method. The signal line driving circuit has an output buffer section configured to amplify input data for driving the signal lines in order to generate the positive-polarity signal voltage as well as the negative-polarity signal voltage and selectively supplying the positive-polarity signal voltage as well as the negative-polarity signal voltage to a signal-line pair composing of a first one of the signal lines and a second one of the signal lines. The output buffer section employs a positive-polarity operational transconductance amplifier configured to amplify the input data in order to generate the positive-polarity signal voltage, a negative-polarity operational transconductance amplifier configured to amplify the input data in order to generate the negative-polarity signal voltage, a first output section configured to supply the positive-polarity signal voltage or the negative-polarity signal voltage to the first signal line, and a second output section configured to supply the positive-polarity signal voltage or the negative-polarity signal voltage to the second signal line. The output buffer section further employs a group of switches which are provided respectively on a forward path between the output node of the positive-polarity operational transconductance amplifier and an input node of the first output section, on a forward path between the output node of the positive-polarity operational transconductance amplifier and an input node of the second output section, on a forward path between the output node of the negative-polarity operational transconductance amplifier and another input node of the second output section, and on a forward path between the output node of the negative-polarity operational transconductance amplifier and another input node of the first output section. The group of switches are further provided respectively on a feedback path between the output node of the first output section and a specific input node of the positive-polarity operational transconductance amplifier, on a feedback path between the output node of the second output section and the specific input node of the positive-polarity operational transconductance amplifier, on a feedback path between the output node of the second output section and a particular input node of the negative-polarity operational transconductance amplifier and on a feedback path between the output node of the first output section and the particular input node of the negative-polarity operational transconductance amplifier. Each of the first output section and the second output section carries out a process on the positive-polarity signal voltage generated by the positive-polarity operational transconductance amplifier and selectively supplied to the first and second output sections by the group of switches in a voltage range between a power-supply voltage and an intermediate reference voltage set between the power-supply voltage and a reference voltage, outputting a result of the process. By the same token, each of the first output section and the second output section carries out another process on the negative-polarity signal voltage generated by the negative-polarity operational transconductance amplifier and selectively supplied to the first and second output sections by the group of switches in another voltage range between the reference voltage and an intermediate power-supply voltage set between the power-supply voltage and the reference voltage, outputting a result of the other process.

In accordance with the signal-line driving circuit, the display apparatus and the electronic apparatus, which are provided by the present embodiment, is possible to prevent the configuration of the signal-line driving circuit from undesirably becoming complicated, the power consumption of the signal-line driving circuit from inevitably increasing and characteristics of the circuit from deteriorating as well as possible to reduce the device size (or the size of the layout area) of the signal-line driving circuit.

In addition, since the present embodiment also provides an offset cancel effect of an amplifier provided at the output stage of the signal-line driving circuit employed in the display apparatus included in the electronic apparatus, the present embodiment contributes to improvement of the quality of an image displayed by the display apparatus.

### BRIEF DESCRIPTION OF THE DRAWINGS

FIG. 1 is a block diagram showing a rough configuration of an ordinary liquid-crystal display apparatus;

FIG. 2 is a block diagram showing a typical configuration of a signal-line driving circuit employed in the liquid-crystal display apparatus shown in the block diagram of FIG. 1 to serve as an ordinary signal-line driving circuit which is configured to make use of an output selector;

FIG. 3 is a block diagram showing a typical configuration of a buffer/amplifier section and an output selector which are employed in the signal-line driving circuit shown in the block diagram of FIG. 2;

FIG. 4 is a block diagram showing a typical configuration of a liquid-crystal display apparatus according to a preferred embodiment of the present invention;

FIG. 5 is a diagram showing a typical configuration of an effective display section employed in the liquid-crystal display apparatus shown in the block diagram of FIG. 4 according to the present embodiment;

FIG. 6 is a block diagram showing a typical configuration of a signal-line driving circuit employed in the liquid-crystal display apparatus shown in the block diagram of FIG. 4 according to the present embodiment;

FIG. 7 is a block diagram showing a typical configuration of a buffer/amplifier section employed in the signal-line driving circuit shown in the block diagram of FIG. 6 according to the present embodiment;

FIG. 8 is a circuit diagram showing a typical configuration of the buffer/amplifier section by particularly depicting details of typical concrete circuit configurations of a positive-polarity OTA and a negative-polarity OTA which are employed in the buffer/amplifier section;

FIG. 9 is a circuit diagram showing a typical configuration of the buffer/amplifier section by particularly depicting details of typical concrete circuit configurations of a first OAMP and a second OAMP which are employed in the buffer/amplifier section;

FIGS. 10A to 10F are timing diagrams showing a plurality of timing charts to be referred to in explanation of operations carried out by the buffer/amplifier section according to the present embodiment;

FIG. 11 is an explanatory diagram showing a mechanism for reducing the power consumption of the signal-line driving circuit according to the present embodiment;

FIG. 12 is a circuit diagram to be referred to in explanation of a rail-to-rail method adopted by the buffer/amplifier section;

FIG. 13 is a circuit diagram to be referred to in explaining the principle of generation of a rush current;

FIGS. 14A and 14B are a plurality of explanatory diagrams to be referred to in comparison of the layout image of the existing output buffer section serving as a typical comparison configuration adopting an output selector method with the layout image of the buffer/amplifier section according to the present embodiment;

FIG. 15 is a diagram showing a perspective view of a TV which serves as an electronic apparatus employing the active-matrix liquid-crystal display apparatus according to the present embodiment;

FIGS. 16A and 16B are a plurality of diagrams each showing a perspective view of a digital camera which serves as an electronic apparatus employing the active-matrix liquid-crystal display apparatus according to the present embodiment;

FIG. 17 is a diagram showing a perspective view of a notebook personal computer which serves as an electronic apparatus employing the active-matrix liquid-crystal display apparatus according to the present embodiment;

FIG. 18 is a diagram showing a perspective view of a video camera which serves as an electronic apparatus employing the active-matrix liquid-crystal display apparatus according to the present embodiment; and

FIGS. 19A to 19G are a plurality of diagrams each showing a view of a portable terminal apparatus such as a cellular phone which serves as an electronic apparatus employing the active-matrix liquid-crystal display apparatus according to the present embodiment.

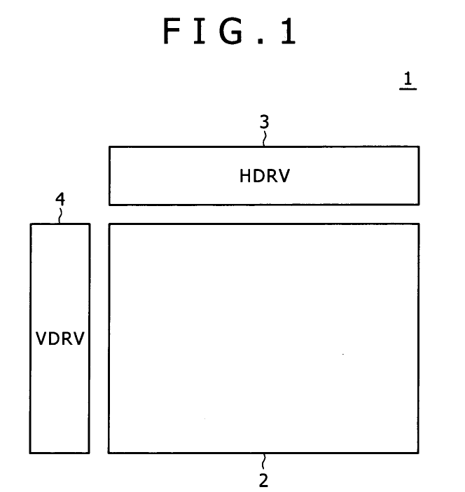

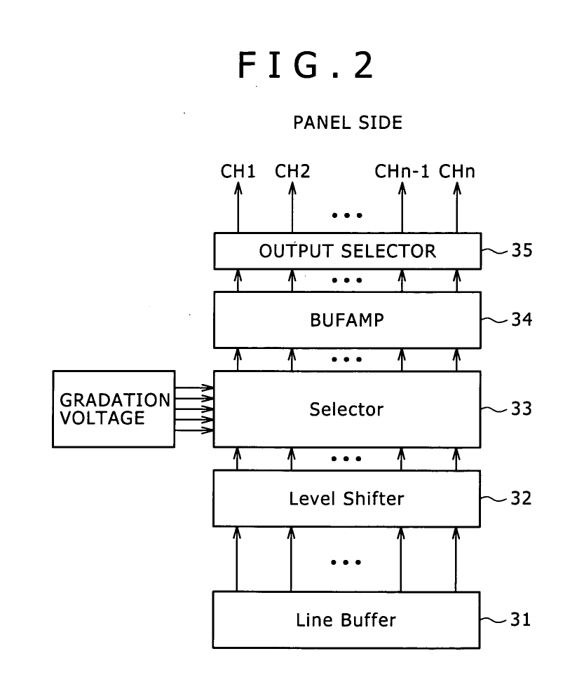

### DETAILED DESCRIPTION OF THE PREFERRED EMBODIMENT

A preferred embodiment of the present invention is explained in detail by referring to the diagrams. It is to be noted that the preferred embodiment is described in chapters which are arranged as follows:

### 1: Typical Configuration of the Display Apparatus

### 2: Typical Configuration of the Signal-Line Driving Circuit

### 3: Modified Versions

### 4: Typical Electronic Apparatus

### 1: Typical Configuration of the Display Apparatus

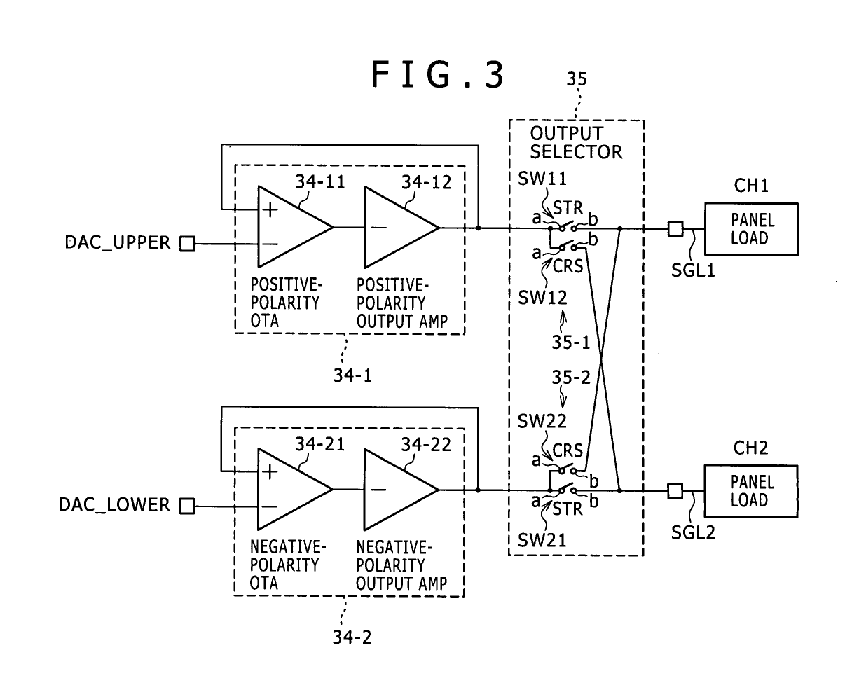

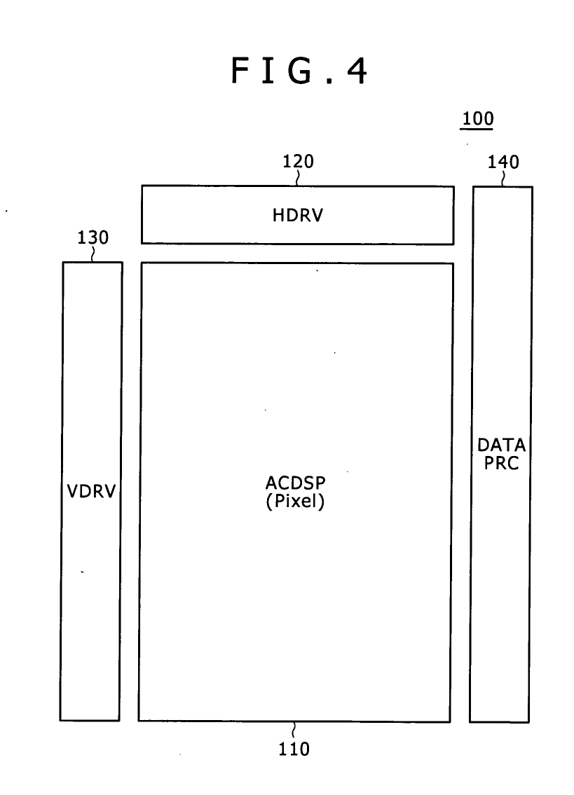

FIG. 4 is a block diagram showing a typical configuration of a liquid-crystal display apparatus 100 according to an embodiment of the present invention.

For example, the liquid-crystal display apparatus 100 explained below is an active-matrix liquid-crystal display apparatus which employs pixels each including a liquid-crystal cell serving as an electro-optical device.

As shown in the block diagram of FIG. 4, the liquid-crystal display apparatus 100 has an effective display section (ACDSP) 110 created on a transparent insulation base such as a glass substrate on which a plurality of pixels are laid out to form a pixel matrix. Since each of the pixels employs a liquid-crystal cell, the pixel matrix is also referred to as a cell matrix mentioned before.

On top of that, the liquid-crystal display apparatus 100 also employs a signal-line driving circuit 120 which is also referred to as a source driver or a horizontal driving circuit denoted by reference notation HDRV in the block diagram of FIG. 4.

In addition, the liquid-crystal display apparatus 100 also employs a gate-line driving circuit 130 which is also referred to as a gate driver or a vertical driving circuit denoted by reference notation VDRV in the block diagram of FIG. 4. Moreover, the liquid-crystal display apparatus 100 also includes a data processing circuit 140 denoted by reference notation DATAPRC in the block diagram of FIG. 4.

The following description sequentially explains the configuration and function of each of the elements which are employed in the liquid-crystal display apparatus 100 according to the present embodiment.

A plurality of pixels each employing a liquid-crystal cell are laid out to form a pixel matrix on the effective display section 110 which is also referred to hereafter simply as a display section.

The effective display section 110 also includes signal lines (each also referred to as a data line) driven by the signal-line driving circuit 120 and gate lines (each also referred to as a vertical scan line) driven by the gate-line driving circuit 130. The signal lines and the gate lines are laid out on the effective display section 110 to form a line matrix which has a lattice shape.

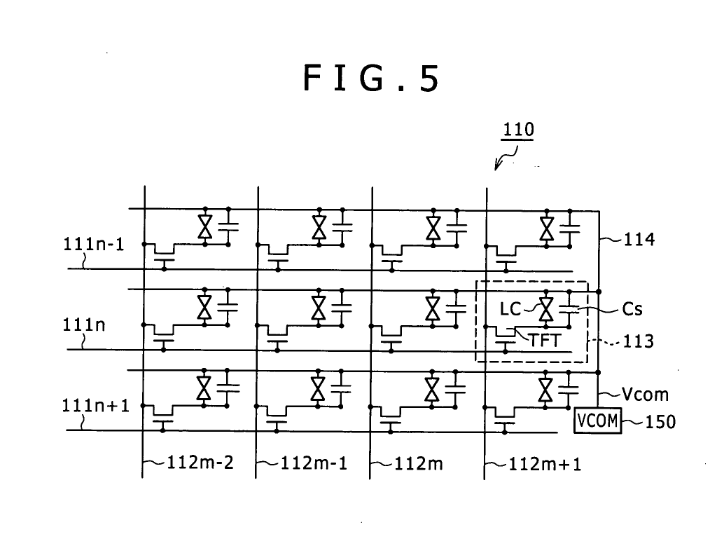

FIG. 5 is a diagram showing a typical configuration of the effective display section 110 employed in the liquid-crystal display apparatus 100 shown in the block diagram of FIG. 4 to serve as an effective display section according to the present embodiment.

In order to simplify the diagram of FIG. 5, the effective display section 110 is shown as a typical pixel matrix which composes of 3 pixel rows and 4 pixel columns. In the diagram, the 3 pixel rows are rows (n−1) to (n+1) whereas the 4 pixel columns are columns (m−2) to (m+1).

In the diagram of FIG. 5, the line matrix of the effective display section 110 thus has 3 gate lines (or 3 vertical scan lines) which are denoted by reference notations 111n−1, 111n and 111n+1 respectively. In addition, the line matrix of the effective display section 110 thus has 4 signal lines (or 4 data lines) which are denoted by reference notations 112m−2, 112m−1, 112m and 112m+1 respectively. At the intersection of any of the gate lines and any of the signal lines, a single pixel 113 is provided.

The single pixel 113 employs a pixel transistor TFT (thin-film transistor), a liquid-crystal cell LC and a signal holding capacitor Cs.

The liquid crystal LC is actually a capacitor existing between a pixel electrode and a facing electrode exposed to the pixel electrode through the capacitor. The pixel electrode of the liquid crystal LC is an electrode connected to the drain of the thin-film transistor TFT. In the following description, the pixel electrode and the facing electrode are also referred to as a particular electrode and the other electrode respectively.

The gate of the thin-film transistor TFT is connected to a gate line which is one of the gate lines (or the vertical scan lines) 111n−1, 111n and 111n+1 and so on. On the other hand, the source of the thin-film transistor TFT is connected to a signal line which is one of the signal lines (or the data lines) 112m−2, 112m−1. 112m and 112m+1 and so on.

As described above, the pixel electrode of the liquid crystal LC is connected to the drain of the thin-film transistor TFT whereas the facing electrode of the liquid crystal LC is connected to a common line 114. The signal holding capacitor Cs is connected between the drain of the thin-film transistor TFT and the common line 114 in parallel to the liquid crystal LC.

The common line 114 is driven by a common voltage Vcom generated by a common voltage supply circuit 150 which is also referred to simply as a VCOM circuit. The common voltage Vcom is an AC (alternating current) voltage having a frequency determined in advance.

Each of the gate lines (or the vertical scan lines) 111n−1, 111n and 111n+1 and so on of the effective display section 110 is connected to an output node of the gate-line driving circuit 130 shown in the block diagram of FIG. 4.

The gate-line driving circuit 130 is for example configured to employ a shift register for sequentially shifting a vertical select pulse synchronously with a vertical transfer clock signal VCK not shown in the block diagram of FIG. 4 and sequentially applying the vertical select pulse to the gate lines (or the vertical scan lines) 111n−1, 111n and 111n+1 and so on in the so-called vertical scan operation.

On the other hand, each of the signal lines (or the data lines) 112m−2, 112m−1, 112m and 112m+1 and so on of the effective display section 110 is connected to an output node of the signal-line driving circuit 120 shown in the block diagram of FIG. 4. The output node included in the signal-line driving circuit 120 to serve as a node connected to the signal line 112 corresponds to a line-matrix column for the signal line 112.

The signal-line driving circuit 120 has a function to convert digital driving data for driving a signal line 112 into analog driving data in accordance with a gradation voltage supplied to the signal-line driving circuit 120. Prior to the digital-to-analog conversion, the level of the driving data has been converted to a driving level. In addition, the signal-line driving circuit 120 also has a function to amplify the analog driving data as well as a function to generate a signal voltage with the positive polarity and a signal voltage with the negative polarity from the amplified analog driving data.

On top of that, the signal-line driving circuit 120 also has a function to selectively supply the signal voltages with positive and negative polarities respectively to signal lines 112 which are adjacent to each other.

The data processing circuit 140 for example has a level shifter for shifting the level of parallel data received from an external source to a level determined in advance.

In addition, the data processing circuit 140 also includes a serial-to-parallel converter for converting serial data having the level thereof shifted into parallel data for the purposes of phase adjustment and frequency reduction. The serial-to-parallel converter outputs the parallel data to the signal-line driving circuit 120.

The following description concretely explains the configuration of the signal-line driving circuit 120 according to the present embodiment and functions of the signal-line driving circuit 120.

### 2: Typical Configuration of the Signal-Line Driving Circuit

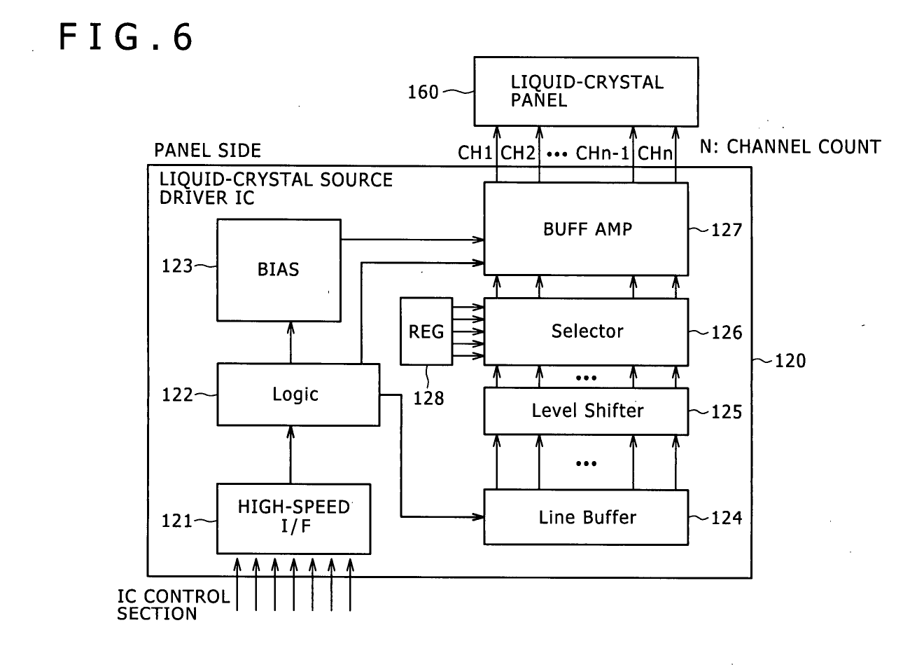

FIG. 6 is a block diagram showing a typical configuration of the signal-line driving circuit 120 employed in the liquid-crystal display apparatus 100 shown in the block diagram of FIG. 4 to serve as a signal-line driving circuit according to the present embodiment.

The signal-line driving circuit 120 shown in the block diagram of FIG. 6 employs a high-speed interface section (I/F) 121, a logic circuit 122, a bias section (BIAS) 123, a line buffer 124, a level shifter 125, a selector section 126, a buffer/amplifier section 127 and a register section 128. The buffer/amplifier section 127 serves as the output buffer section cited before.

The logic circuit 122 is a section for carrying out a parallel-to-serial conversion of converting parallel data received from the high-speed interface section 121 into serial data and supplying the serial data obtained as a result of the parallel-to-serial conversion to the line buffer 124 to be used as driving data.

In addition, the logic circuit 122 also controls the bias section 123 in order to adjust the biasing state of output-stage amplifiers employed in the buffer/amplifier section 127.

The bias section 123 is a section for selectively outputting a bias signal to the output-stage amplifiers employed in the buffer/amplifier section 127 in accordance with the control executed by the logic circuit 122.

The line buffer 124 is a memory used for storing the driving data supplied thereto by the logic circuit 122 as a result of the parallel-to-serial conversion. The driving data is data used for driving the signal lines.

The level shifter 125 is a section for changing the level of the driving data received from the line buffer 124 to a driving level.

The selector section 126 employs a plurality of DACs (digital-to-analog converters) each used for converting the digital driving data output by the level shifter 125 into analog driving data in accordance with gradation voltages received from the register section 128.

The buffer/amplifier section 127 functioning as the output buffer section is a section for amplifying the driving data received from the selector section 126 in order to generate a signal voltage with the positive polarity and a signal voltage with the negative polarity from the amplified driving data.

The buffer/amplifier section 127 selectively supplies the signal voltage with the positive polarity and the signal voltage with the negative polarity to a signal-line pair composing of signal lines laid out on a liquid-crystal panel 160 along 2 pixel columns adjacent to each other in the line matrix.

In actuality, each of the signal lines is associated with a channel of the buffer/amplifier section 127. A channel count n representing the number of channels in the buffer/amplifier section 127 has a value of not smaller than 100. Thus, the buffer/amplifier section 127 is a section for driving the signal lines which are each associated with a channel.

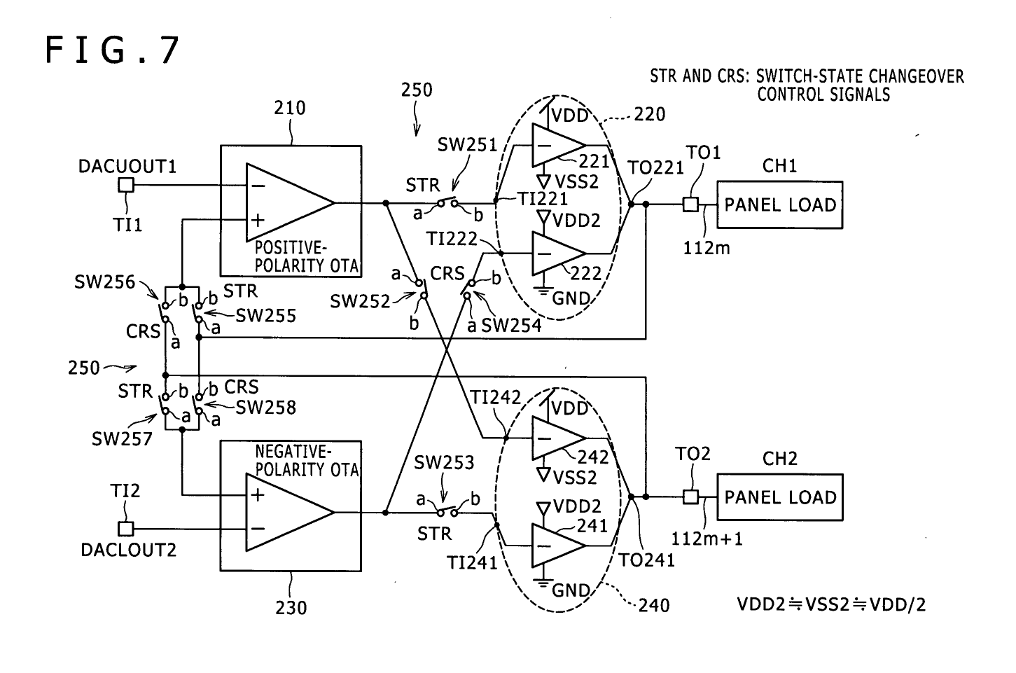

FIG. 7 is a block diagram showing a typical configuration of the buffer/amplifier section 127 employed in the signal-line driving circuit 120 shown in the block diagram of FIG. 6 to serve as a buffer/amplifier section according to the present embodiment.

In the following description, the buffer/amplifier section 127 is denoted by reference numeral 200.

The buffer/amplifier section 200 shown in the block diagram of FIG. 7 employs a positive-polarity OTA (Operational Transconductance Amplifier) 210 having a function to amplify the driving data output by a DAC employed in the selector section 126 provided at the preceding stage as a DAC with the output node thereof connected to the positive-polarity OTA 210 and a function to generate a signal voltage with the positive polarity from the amplified driving data. By the same token, the buffer/amplifier section 200 also employs a negative-polarity OTA 230 having a function to amplify the driving data output by another DAC employed in the selector section 126 provided at the preceding stage as a DAC with the output node thereof connected to the negative-polarity OTA 230 and a function to generate a signal voltage with the negative polarity from the amplified driving data.

As described above, the buffer/amplifier section 200 functions as an output buffer. To put it in detail, the buffer/amplifier section 200 employs a first OAMP (Output Amplifier section) 220 serving as a first output section for receiving the signal voltage with the positive polarity from the positive-polarity OTA 210 or the signal voltage with the negative polarity from the negative-polarity OTA 230 and for supplying the signal voltage with the positive polarity or the signal voltage with the negative polarity to a first signal line 112m associated with a channel CHm where, for example, m=1.

By the same token, functioning as an output buffer, the buffer/amplifier section 200 also employs a second OAMP 240 serving as a second output section for receiving the signal voltage with the positive polarity from the positive-polarity OTA 210 or the signal voltage with the negative polarity from the negative-polarity OTA 230 and for supplying the signal voltage with the positive polarity or the signal voltage with the negative polarity to a second signal line 112m+1 associated with a channel CHm+1 where, in this case, (m+1)=2.

The first signal line 112m and the second signal line 112m+1 form the aforementioned signal-line pair composing of the first signal line 112m and the second signal line 112m+1 which are laid out on the liquid-crystal panel 160 along 2 pixel columns adjacent to each other in the line matrix.

As described above, the first OAMP 220 serves as the first output section whereas the second OAMP 240 serves as the second output section.

In addition, the buffer/amplifier section 200 also employs a switch group 250 which composes of a first switch SW251, a second switch SW252, a third switch SW253, a fourth switch SW254, a fifth switch SW255, a sixth switch SW256, a seventh switch SW257 and an eighth switch SW258.

The switch group 250 is connected as follows. The first switch SW251 is provided on a forward path between the output node of the positive-polarity operational transconductance amplifier 210 and an input node of the first OAMP 220 whereas the second switch SW252 is provided on a forward path between the output node of the positive-polarity operational transconductance amplifier 210 and an input node of the second OAMP 240. The third switch SW253 is provided on a forward path between the output node of the negative-polarity operational transconductance amplifier 230 and another input node of the second OAMP 240 whereas the fourth switch SW254 is provided on a forward path between the output node of the negative-polarity operational transconductance amplifier 230 and another input node of the first OAMP 220.

The remaining switches of the switch group 250 are connected as follows. The fifth switch SW255 is provided on a feedback path between the output node of the first OAMP 220 and a specific input node of the positive-polarity operational transconductance amplifier 210 whereas the sixth switch SW256 is provided on a feedback path between the output node of the second OAMP 240 and the specific input node of the positive-polarity operational transconductance amplifier 210. The seventh switch SW257 is provided on a feedback path between the output node of the second OAMP 240 and a particular input node of the negative-polarity operational transconductance amplifier 230 whereas the eighth switch SW258 is provided on a feedback path between the output node of the first OAMP 220 and the particular input node of the negative-polarity operational transconductance amplifier 230.

The first OAMP 220 according to the present embodiment employs a first output amplifier 221 and a second output amplifier 222 which are used for receiving a signal voltage with the positive polarity from the positive-polarity OTA 210 and a signal voltage with the negative polarity from the negative-polarity OTA 230 respectively. The first output amplifier 221 operates in a power-supply voltage range different from a power-supply voltage range in which the second output amplifier 222 operates. By the same token, the second OAMP 240 according to the present embodiment employs a third output amplifier 241 for receiving a signal voltage with the negative polarity from the negative-polarity OTA 230 and a fourth output amplifier 242 for receiving a signal voltage with the positive polarity from the positive-polarity OTA 210. The third output amplifier 241 operates in the same power-supply voltage range as the second output amplifier 222 whereas the fourth output amplifier 242 operates in the same power-supply voltage range as the first output amplifier 221.

Normally, an output amplifier operates in a voltage range between a power-supply voltage VDD and a reference voltage VSS which is normally the electric potential of the ground.

However, the first output amplifier 221 employed in the first OAMP 220 operates in a voltage range between the power-supply voltage VDD and an intermediate reference voltage VSS2 whereas the second output amplifier 222 employed in the first OAMP 220 operates in a voltage range between an intermediate power-supply voltage VDD2 and the reference voltage VSS. By the same token, the fourth output amplifier 242 employed in the second OAMP 240 operates in the voltage range between the power-supply voltage VDD and the intermediate reference voltage VSS2 whereas the third output amplifier 241 employed in the second OAMP 240 operates in the voltage range between the intermediate power-supply voltage VDD2 and the reference voltage VSS. Each of the intermediate reference voltage VSS2 and the intermediate power-supply voltage VDD2 is set at a level between the reference voltage VSS and the power-supply voltage VDD.

It is to be noted that the description given below assumes that the following equations hold true: VDD2. VSS2. VDD/2. However, the intermediate power-supply voltage VDD2 and the intermediate reference voltage VSS2 do not have to be set at the same level.

The first OAMP 220 has the first output amplifier 221 and the second output amplifier 222 as described above in addition to a first input node TI221, a second input node TI222 and an output node TO221.

Also as explained above, the first output amplifier 221 is configured to operate in a voltage range between the power-supply voltage VDD and the intermediate reference voltage VSS2.

The positive-polarity OTA 210 outputs a signal voltage with the positive polarity to the first output amplifier 221 by way of the first switch SW251 and the first input node TI221 as a voltage to be amplified by the first output amplifier 221 which then supplies the amplified signal voltage to the output node TO221.

Also as explained above, the second output amplifier 222 is configured to operate in a voltage range between the intermediate power-supply voltage VDD2 and the reference voltage VSS which is the electric potential of the ground GND.

The negative-polarity OTA 230 outputs a signal voltage with the negative polarity to the second output amplifier 222 by way of the fourth switch SW254 and the second input node TI222 as a voltage to be amplified by the second output amplifier 222 which then supplies the amplified signal voltage to the output node TO221.

The second OAMP 240 has the third output amplifier 241 and the fourth output amplifier 242 as described above in addition to a third input node TI241, a fourth input node TI242 and an output node TO241.

Also as explained above, the third output amplifier 241 is configured to operate in a voltage range between the intermediate power-supply voltage VDD2 and the reference voltage VSS which is the electric potential of the ground GND.

The negative-polarity OTA 230 outputs a signal voltage with the negative polarity to the third output amplifier 241 by way of the third switch SW253 and the third input node TI241 as a voltage to be amplified by the third output amplifier 241 which then supplies the amplified signal to the output node TO241.

Also as explained above, the fourth output amplifier 242 is configured to operate in a voltage range between the power-supply voltage VDD and the intermediate reference voltage VSS2.

The positive-polarity OTA 210 outputs a signal voltage with the positive polarity to the fourth output amplifier 242 by way of the second switch SW252 and the fourth input node TI242 as a voltage to be amplified by the fourth output amplifier 242 which then supplies the amplified signal to the output node TO241.

As described above, the positive-polarity OTA 210 outputs a signal voltage with the positive polarity to the first output amplifier 221 employed in the first OAMP 220 by way of the first switch SW251 and the first input node TI221 of the first OAMP 220 and to the fourth output amplifier 242 employed in the second OAMP 240 by way of the second switch SW252 and the fourth input node TI242 of the second OAMP 240.

By the same token, the negative-polarity OTA 230 outputs a signal voltage with the negative polarity to the third output amplifier 241 employed in the second OAMP 240 by way of the third switch SW253 and the third input node TI241 of the second OAMP 240 and to the second output amplifier 222 employed in the first OAMP 220 by way of the fourth switch SW254 and the second input node TI222 of the first OAMP 220.

The inverting input node (−) of the positive-polarity OTA 210 is connected to an input node TI1 wired to the output node of a DAC employed in the selector section 126 provided at the preceding stage whereas the non-inverting input node (+) of the positive-polarity OTA 210 is connected to the output node TO221 of the first OAMP 220 through the fifth switch SW255 and to the output node TO241 of the second OAMP 240 through the sixth switch SW256.

By the same token, the inverting input node (−) of the negative-polarity OTA 230 is connected to an input node TI2 wired to the output node of another DAC employed in the selector section 126 provided at the preceding stage whereas the non-inverting input node (+) of the negative-polarity OTA 230 is connected to the output node TO241 of the second OAMP 240 through the seventh switch SW257 and to the output node TO221 of the first OAMP 220 through the eighth switch SW258.

The output node TO221 of the first OAMP 220 is connected to an output node TO1 wired to a first signal line 112m associated with the channel CH1.

The output node TO241 of the second OAMP 240 is connected to an output node TO2 wired to a second signal line 112m+1 associated with the channel CH2.

The first switch SW251, the third switch SW253, the fifth switch SW255 and the seventh switch SW257 form a first switch group of the switch group 250. The first switch SW251, the third switch SW253, the fifth switch SW255 and the seventh switch SW257 are controlled to enter a turned-on state or a turned-off state by the common switch-state changeover control signal STR which serves as a common switch-state changeover signal common to the first switch SW251, the third switch SW253, the fifth switch SW255 and the seventh switch SW257.

On the other hand, the second switch SW252, the fourth switch SW254, the sixth switch SW256 and the eighth switch SW258 form a second switch group of the switch group 250. The second switch SW252, the fourth switch SW254, the sixth switch SW256 and the eighth switch SW258 are controlled to enter a turned-on state or a turned-off state by the common switch-state changeover control signal CRS which serves as a common switch-state changeover signal common to the second switch SW252, the fourth switch SW254, the sixth switch SW256 and the eighth switch SW258.

The first switch SW251, the third switch SW253, the fifth switch SW255 and the seventh switch SW257 which pertain to the first switch group are put in a turned-on state or a turned-off state by the common switch-state changeover control signal STR complementarily to the second switch SW252, the fourth switch SW254, the sixth switch SW256 and the eighth switch SW258 which pertain to the second switch group. Conversely, the second switch SW252, the fourth switch SW254, the sixth switch SW256 and the eighth switch SW258 are put in a turned-on state or a turned-off state by the common switch-state changeover control signal CRS complementarily to the first switch SW251, the third switch SW253, the fifth switch SW255 and the seventh switch SW257.

That is to say, a control system shown in none of the figures executes such control that, when the common switch-state changeover control signal STR is set at a high level, the common switch-state changeover control signal CRS is set at a low level and, when the common switch-state changeover control signal STR is set at a low level, the common switch-state changeover control signal CRS is set at a high level.

For example, when the common switch-state changeover control signal STR is set at a high level, the first switch SW251, the third switch SW253, the fifth switch SW255 and the seventh switch SW257 which pertain to the first switch group are put in a turned-on state. When the common switch-state changeover control signal STR is set at a low level, on the other hand, the first switch SW251, the third switch SW253, the fifth switch SW255 and the seventh switch SW257 are put in a turned-off state.

By the same token, when the common switch-state changeover control signal CRS is set at a high level, the second switch SW252, the fourth switch SW254, the sixth switch SW256 and the eighth switch SW258 which pertain to the second switch group are put in a turned-on state. When the common switch-state changeover control signal CRS is set at a low level, on the other hand, the second switch SW252, the fourth switch SW254, the sixth switch SW256 and the eighth switch SW258 are put in a turned-off state.

It is to be noted that, in the present embodiment, control is executed to prohibit the common switch-state changeover control signal STR and the common switch-state changeover control signal CRS from being set at the high level at the same time.

In the present embodiment, a state of sustaining the common switch-state changeover control signal STR at a high level is referred to as a first mode whereas a state of sustaining the common switch-state changeover control signal CRS at a high level is referred to as a second mode.

A node a of the first switch SW251 is connected to the output node of the positive-polarity OTA 210 whereas a node b of the first switch SW251 is connected to the first input node TI221 of the first OAMP 220.

A node a of the second switch SW252 is connected to the output node of the positive-polarity OTA 210 whereas a node b of the second switch SW252 is connected to the fourth input node TI242 of the second OAMP 240.

A node a of the third switch SW253 is connected to the output node of the negative-polarity OTA 230 whereas a node b of the third switch SW253 is connected to the third input node TI241 of the second OAMP 240.

A node a of the fourth switch SW254 is connected to the output node of the negative-polarity OTA 230 whereas a node b of the fourth switch SW254 is connected to the second input node TI222 of the first OAMP 220.

A node a of the fifth switch SW255 is connected to the output node TO221 of the first OAMP 220 whereas a node b of the fifth switch SW255 is connected to the non-inverting input node (+) of the positive-polarity OTA 210.

A node a of the sixth switch SW256 is connected to the output node TO241 of the second OAMP 240 whereas a node b of the sixth switch SW256 is connected to the non-inverting input node (+) of the positive-polarity OTA 210.

A node b of the seventh switch SW257 is connected to the output node TO241 of the second OAMP 240 whereas a node a of the seventh switch SW257 is connected to the non-inverting input node (+) of the negative-polarity OTA 230.

A node b of the eighth switch SW258 is connected to the output node TO221 of the first OAMP 220 whereas a node a of the eighth switch SW258 is connected to the non-inverting input node (+) of the negative-polarity OTA 230.

As described earlier, the first OAMP 220 employs 2 output amplifiers, i.e., the first output amplifier 221 and the second output amplifier 222. It is to be noted that the first OAMP 220 may employ more than 2 output amplifiers. By the same token, the second OAMP 240 employs 2 output amplifiers, i.e., the third output amplifier 241 and the fourth output amplifier 242. It is also worth noting that the second OAMP 240 may employ more than 2 output amplifiers.

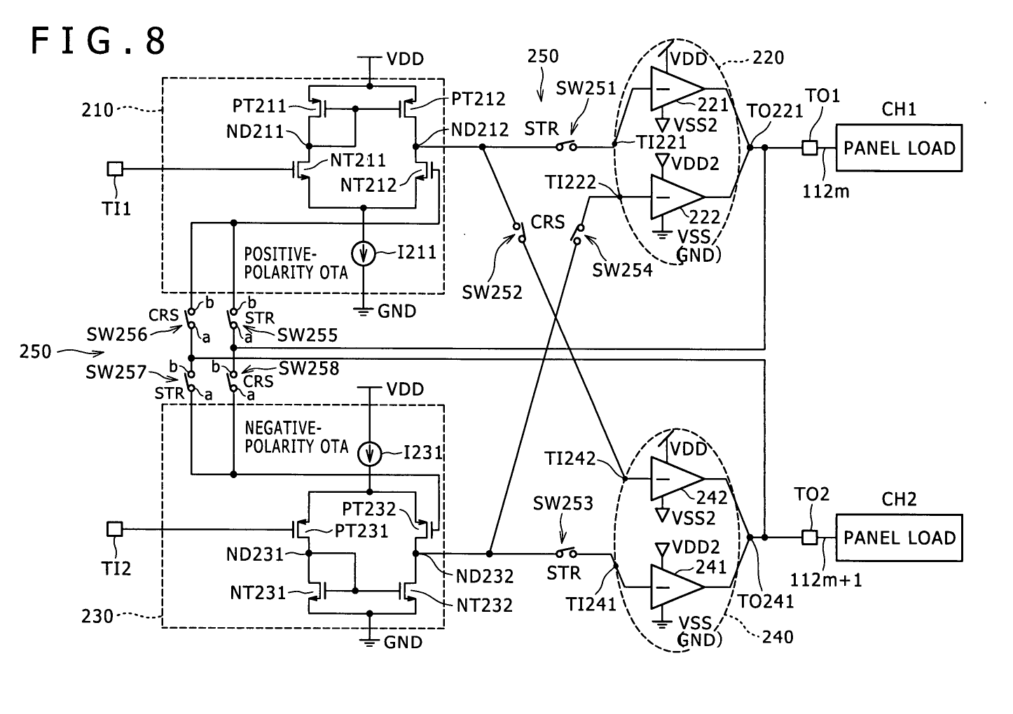

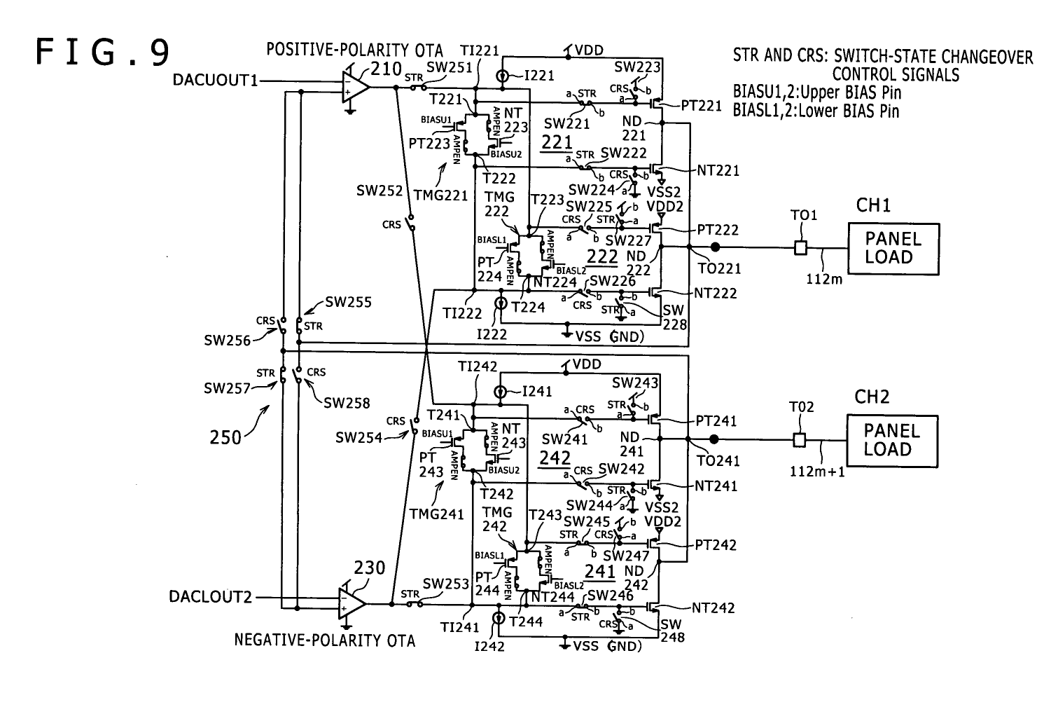

FIG. 8 is a circuit diagram showing a typical configuration of the buffer/amplifier section 200 by particularly depicting details of typical concrete circuit configurations of the positive-polarity OTA 210 and the negative-polarity OTA 230 which are employed in the buffer/amplifier section 200. FIG. 9 is a circuit diagram showing a typical configuration of the buffer/amplifier section 200 by particularly depicting details of typical concrete circuit configurations of the first OAMP 220 and the second OAMP 240 which are employed in the buffer/amplifier section 200.

As shown in the circuit diagram of FIG. 8, the positive-polarity OTA 210 employs PMOS (P-channel MOS) transistors PT211 and PT212 of the first conduction type, NMOS (N-channel MOS) transistors NT211 and NT212 of the second conduction type and a current source I211.

The source of the PMOS transistor PT211 and the source of the PMOS transistor PT212 are connected to a source for supplying the power-supply voltage VDD.

The drain of the PMOS transistor PT211 and the drain of the NMOS transistor NT211 are connected to each other by a connection point which is used as a node ND211. The drain of the PMOS transistor PT211 is connected to the gate of the PMOS transistor PT211 by a connection point which is wired to the gate of the PMOS transistor PT212.

The drain of the PMOS transistor PT212 and the drain of the NMOS transistor NT212 are connected to each other by a connection point which is used as the output node ND212 of the positive-polarity OTA 210.

The source of the NMOS transistor NT211 and the source of the NMOS transistor NT212 are connected by a connection point which is wired to the drain of the current source I211.

The gate of the NMOS transistor NT212 serves as the non-inverting input node (+) of the positive-polarity OTA 210 whereas the gate of the NMOS transistor NT211 serves as the inverting input node (−) of the positive-polarity OTA 210.

Thus, the gate of the NMOS transistor NT211 is connected to the input node TI1 which is wired to the output node of a DAC employed in the selector section 126 provided at the preceding stage whereas the gate of the NMOS transistor NT212 is connected to the node b of the fifth switch SW255 and the node b of the sixth switch SW256.

The output node ND212 of the positive-polarity OTA 210 is connected to the node a of the first switch SW251 and the node a of the second switch SW252.

The positive-polarity OTA 210 having the configuration described above thus includes a differential amplifier configured to employ the NMOS transistor NT211 and the NMOS transistor NT212. This differential amplifier amplifies the difference between a signal output by the DAC employed in the selector section 126 provided at the preceding stage and a signal fed back from the first OAMP 220 or the second OAMP 240.

The positive-polarity OTA 210 supplies an amplified positive-polarity data signal voltage output by the differential amplifier to the first OAMP 220 by way of the first switch SW251 or the second OAMP 240 by way of the second switch SW252.

As shown in the circuit diagram of FIG. 8, the negative-polarity OTA 230 employs PMOS (P-channel MOS) transistors PT231 and PT232 of the first conduction type, NMOS (N-channel MOS) transistors NT231 and NT232 of the second conduction type and a current source I231.

The source of the PMOS transistor PT231 and the source of the PMOS transistor PT232 are connected to the current source I231 which is wired to the source for supplying the power-supply voltage VDD.

The drain of the PMOS transistor PT231 and the drain of the NMOS transistor NT231 are connected to each other by a connection point which is used as a node ND231. The drain of the NMOS transistor NT231 is connected to the gate of the NMOS transistor NT231 by a connection point which is wired to the gate of the NMOS transistor NT232.

The drain of the PMOS transistor PT232 and the drain of the NMOS transistor NT232 are connected to each other by a connection point which is used as the output node ND232 of the negative-polarity OTA 230.

The source of the NMOS transistor NT231 and the source of the NMOS transistor NT232 are connected by a connection point which is wired to the ground GND.

The gate of the PMOS transistor PT232 serves as the non-inverting input node (+) of the negative-polarity OTA 230 whereas the gate of the PMOS transistor PT231 serves as the inverting input node (−) of the negative-polarity OTA 230.

Thus, the gate of the PMOS transistor PT231 is connected to the input node TI2 which is wired to the output node of another DAC employed in the selector section 126 provided at the preceding stage whereas the gate of the PMOS transistor PT232 is connected to the node a of the seventh switch SW257 and the node a of the eighth switch SW258.

The output node ND232 of the negative-polarity OTA 230 is connected to the node a of the third switch SW253 and the node a of the fourth switch SW254.

The negative-polarity OTA 230 having the configuration described above thus includes a differential amplifier configured to employ the PMOS transistor PT231 and the PMOS transistor PT232. This differential amplifier amplifies the difference between a signal output by the other DAC employed in the selector section 126 provided at the preceding stage and a signal fed back from the first OAMP 220 or the second OAMP 240.

The negative-polarity OTA 230 supplies an amplified negative-polarity data signal voltage output by the differential amplifier to the second OAMP 240 by way of the third switch SW253 or the first OAMP 220 by way of the fourth switch SW254.

As shown in the circuit diagram of FIG. 9, the first OAMP 220 employs a PMOS transistor PT221, a PMOS transistor PT222, an NMOS transistor NT221, an NMOS transistor NT222, a current source I221, a current source I222, a transmission gate TMG221, a transmission gate TMG222 and switches SW221 to SW228.

In the first OAMP 220, the current source I221 and the current source I222 are shared by the first output amplifier 221 and the second output amplifier 222 which form the first OAMP 220.

The first output amplifier 221 includes the PMOS transistor PT221, the NMOS transistor NT221, the transmission gate TMG221 and the switches SW221 to SW224.

It is to be noted that the switches SW221 to SW224 are not necessarily demanded in some cases.

The source of the PMOS transistor PT221 is connected to the source for supplying the power-supply voltage VDD whereas the drain of the PMOS transistor PT221 is connected to the drain of the NMOS transistor NT221 by a connection point which is used as a node ND221. The source of the NMOS transistor NT221 is connected to a source for supplying the intermediate reference voltage VSS2. The node ND221 is connected to the output node TO221 of the first OAMP 220.

The current source I221 is connected to the source for supplying the power-supply voltage VDD.

The current source I221, the gate of the PMOS transistor PT221 and a specific input/output node T221 of the transmission gate TMG221 are connected to each other by a connection point which is used as a first input node TI221 of the first OAMP 220.

The current source I222 is connected to the ground GND for supplying the reference voltage VSS.

The current source I222, the gate of the NMOS transistor NT221 and the other input/output node T222 of the transmission gate TMG221 are connected to each other by a connection point which is used as a second input node TI222 of the first OAMP 220.

In the transmission gate TMG221, the gate of a PMOS transistor PT223 receives a first bias signal BIASU1 whereas the gate of an NMOS transistor NT223 receives a second bias signal BIASU2.

The first bias signal BIASU1 and the second bias signal BIASU2 are applied to the gate of the PMOS transistor PT223 and the gate of the NMOS transistor NT223 respectively to serve as voltages which are used for setting a DC current flowing to the first output amplifier 221 employed in the first OAMP 220 provided at the output stage.

In the present embodiment, the switch SW221 is provided between the first input node TI221 of the first OAMP 220 and the gate of the PMOS transistor PT221. To put it in detail, a node a of the switch SW221 is connected to the first input node TI221 whereas a node b of the switch SW221 is connected to the gate of the PMOS transistor PT221.

The switch SW222 is provided between the other input/output node T222 of the transmission gate TMG221 and the gate of the NMOS transistor NT221. To put it in detail, a node a of the switch SW222 is connected to the other input/output node T222 whereas a node b of the switch SW222 is connected to the gate of the NMOS transistor NT221.

The switch SW223 is provided between the gate of the PMOS transistor PT221 and the source for supplying the power-supply voltage VDD. To put it in detail, a node a of the switch SW223 is connected to the gate of the PMOS transistor PT221 whereas a node b of the switch SW223 is connected to the source for supplying the power-supply voltage VDD.

The switch SW224 is provided between the gate of the NMOS transistor NT221 and the ground GND. To put it in detail, a node a of the switch SW224 is connected to the ground GND whereas a node b of the switch SW224 is connected to the gate of the NMOS transistor NT221.

The second output amplifier 222 includes the PMOS transistor PT222, the NMOS transistor NT222, the transmission gate TMG222 and the switches SW225 to SW228.

It is to be noted that the switches SW225 to SW228 are not necessarily demanded in some cases.

The source of the PMOS transistor PT222 is connected to the source for supplying the intermediate power-supply voltage VDD2 whereas the drain of the PMOS transistor PT222 is connected to the drain of the NMOS transistor NT222 by a connection point which is used as a node ND222. The source of the NMOS transistor NT222 is connected to the ground GND for supplying the reference voltage VSS. The node ND222 is connected to the output node TO221 of the first OAMP 220.

The current source I221, the gate of the PMOS transistor PT222 and a specific input/output node T223 of the transmission gate TMG222 are connected to each other by a connection point which is used as a first input node TI221 of the first OAMP 220.

The current source I222, the gate of the NMOS transistor NT222 and the other input/output node T224 of the transmission gate TMG222 are connected to each other by a connection point which is used as a second input node TI222 of the first OAMP 220.

In the transmission gate TMG222, the gate of a PMOS transistor PT224 receives a third bias signal BIASL1 whereas the gate of an NMOS transistor NT223 receives a fourth bias signal BIASL2.

The third bias signal BIASL1 and the fourth bias signal BIASL2 are applied to the gate of the PMOS transistor PT224 and the gate of the NMOS transistor NT223 respectively to serve as voltages which are used for setting a DC current flowing to the second output amplifier 222 employed in the first OAMP 220 provided at the output stage.

In the present embodiment, the switch SW225 is provided between the first input node TI221 of the first OAMP 220 and the gate of the PMOS transistor PT222. To put it in detail, a node a of the switch SW225 is connected to the first input node TI221 whereas a node b of the switch SW225 is connected to the gate of the PMOS transistor PT222.

The switch SW226 is provided between the other input/output node T224 of the transmission gate TMG222 and the gate of the NMOS transistor NT222. To put it in detail, a node a of the switch SW226 is connected to the other input/output node T224 whereas a node b of the switch SW226 is connected to the gate of the NMOS transistor NT222.

The switch SW227 is provided between the gate of the PMOS transistor PT222 and the source for supplying the power-supply voltage VDD. To put it in detail, a node a of the switch SW227 is connected to the gate of the PMOS transistor PT222 whereas a node b of the switch SW227 is connected to the source for supplying the power-supply voltage VDD.

The switch SW228 is provided between the gate of the NMOS transistor NT222 and the ground GND. To put it in detail, a node a of the switch SW228 is connected to the ground GND whereas a node b of the switch SW228 is connected to the gate of the NMOS transistor NT222.

In the first OAMP 220, the switches SW221, SW222, SW227 and SW228 are controlled to enter a turned-on state or a turned-off state by the common switch-state changeover control signal STR described earlier.

On the other hand, the switches SW223, SW224, SW225 and SW226 are controlled to enter a turned-on state or a turned-off state by the common switch-state changeover control signal CRS described earlier.

The switches SW221, SW222, SW227 and SW228 are put in a turned-on state or a turned-off state by the common switch-state changeover control signal STR complementarily to the switches SW223, SW224, SW225 and SW226. Conversely, the switches SW223, SW224, SW225 and SW226 are put in a turned-on state or a turned-off state by the common switch-state changeover control signal CRS complementarily to the switches SW221, SW222, SW227 and SW228.

That is to say, a control system shown in none of the figures executes such control that, when the common switch-state changeover control signal STR is set at a high level, the common switch-state changeover control signal CRS is set at a low level and, when the common switch-state changeover control signal STR is set at a low level, the common switch-state changeover control signal CRS is set at a high level.

For example, when the common switch-state changeover control signal STR is set at a high level, the switches SW221, SW222, SW227 and SW228 are put in a turned-on state. When the common switch-state changeover control signal STR is set at a low level, on the other hand, the switches SW221, SW222, SW227 and SW228 are put in a turned-off state.

By the same token, when the common switch-state changeover control signal CRS is set at a high level, the switches SW223, SW224, SW225 and SW226 are put in a turned-on state. When the common switch-state changeover control signal CRS is set at a low level, on the other hand, the switches SW223, SW224, SW225 and SW226 are put in a turned-off state.

In the typical configuration of the buffer/amplifier section 200 shown in the circuit diagram of FIG. 7, the common switch-state changeover control signal STR is set at a high level whereas the common switch-state changeover control signal CRS is set at a low level.

Thus, the switches SW221, SW222, SW227 and SW228 are put in a turned-on state whereas the switches SW223, SW224, SW225 and SW226 are put in a turned-off state.

In this typical state of the configuration, in the first output amplifier 221 shown in the circuit diagram of FIG. 9, a positive-polarity signal voltage output by the positive-polarity OTA 210 is supplied to the gate of the PMOS transistor PT221 by way of the switch SW221 and the gate of the NMOS transistor NT221 by way of the switch SW222, being amplified into an output signal.

In the second output amplifier 222, on the other hand, the gate of the PMOS transistor PT222 is sustained at the level of the power-supply voltage VDD whereas the gate of the NMOS transistor NT222 is sustained at the level of the electric potential of the ground GND. As a result, each of the PMOS transistor PT222 and the NMOS transistor NT222 is sustained in a turned-off state with a high degree of reliability so that the flow of a penetration current is avoided.

The first OAMP 220 functioning as an output buffer with such a configuration carries out an AB-class push-pull operation.

As shown in the circuit diagram of FIG. 9, the second OAMP 240 employs a PMOS transistor PT241, a PMOS transistor PT242, an NMOS transistor NT241, an NMOS transistor NT242, a current source I241, a current source I242, a transmission gate TMG241, a transmission gate TMG242 and switches SW241 to SW248.

In the second OAMP 240, the current source I241 and the current source I242 are shared by the third output amplifier 241 and the fourth output amplifier 242 which form the second OAMP 240.

The fourth output amplifier 242 includes the PMOS transistor PT241, the NMOS transistor NT241, the transmission gate TMG241 and the switches SW241 to SW244.

It is to be noted that the switches SW241 to SW244 are not necessarily demanded in some cases.

The source of the PMOS transistor PT241 is connected to the source for supplying the power-supply voltage VDD whereas the drain of the PMOS transistor PT241 is connected to the drain of the NMOS transistor NT241 by a connection point which is used as a node ND241. The source of the NMOS transistor NT241 is connected to a source for supplying the intermediate reference voltage VSS2. The node ND241 is connected to the output node TO241 of the second OAMP 240.

The current source I241 is connected to the source for supplying the power-supply voltage VDD.

The current source I241, the gate of the PMOS transistor PT241 and a specific input/output node T241 of the transmission gate TMG241 are connected to each other by a connection point which is used as a fourth input node TI242 of the second OAMP 240.

The current source I242 is connected to the ground GND for supplying the reference voltage VSS.

The current source I242, the gate of the NMOS transistor NT241 and the other input/output node T242 of the transmission gate TMG241 are connected to each other by a connection point which is used as a third input node TI241 of the second OAMP 240.

In the transmission gate TMG241, the gate of a PMOS transistor PT243 receives the first bias signal BIASU1 whereas the gate of an NMOS transistor NT243 receives the second bias signal BIASU2.

The first bias signal BIASU1 and the second bias signal BIASU2 are applied to the gate of the PMOS transistor PT243 and the gate of the NMOS transistor NT243 respectively to serve as voltages which are used for setting a DC current flowing to the fourth output amplifier 242 employed in the second OAMP 240 provided at the output stage.

In the present embodiment, the switch SW241 is provided between the fourth input node TI242 of the second OAMP 240 and the gate of the PMOS transistor PT241. To put it in detail, a node a of the switch SW241 is connected to the fourth input node TI242 whereas a node b of the switch SW241 is connected to the gate of the PMOS transistor PT241.

The switch SW242 is provided between the other input/output node T242 of the transmission gate TMG241 and the gate of the NMOS transistor NT241. To put it in detail, a node a of the switch SW242 is connected to the other input/output node T242 whereas a node b of the switch SW242 is connected to the gate of the NMOS transistor NT241.

The switch SW243 is provided between the gate of the PMOS transistor PT241 and the source for supplying the power-supply voltage VDD. To put it in detail, a node a of the switch SW243 is connected to the gate of the PMOS transistor PT241 whereas a node b of the switch SW243 is connected to the source for supplying the power-supply voltage VDD.

The switch SW244 is provided between the gate of the NMOS transistor NT241 and the ground GND. To put it in detail, a node a of the switch SW244 is connected to the ground GND whereas a node b of the switch SW244 is connected to the gate of the NMOS transistor NT241.

The third output amplifier 241 includes the PMOS transistor PT242, the NMOS transistor NT242, the transmission gate TMG242 and the switches SW245 to SW248.

It is to be noted that the switches SW245 to SW248 are not necessarily demanded in some cases.

The source of the PMOS transistor PT242 is connected to the source for supplying the intermediate power-supply voltage VDD2 whereas the drain of the PMOS transistor PT242 is connected to the drain of the NMOS transistor NT242 by a connection point which is used as a node ND242. The source of the NMOS transistor NT242 is connected to the ground GND for supplying the reference voltage VSS. The node ND242 is connected to the output node TO241 of the second OAMP 240.

The current source I242, the gate of the NMOS transistor NT241 and a specific input/output node T244 of the transmission gate TMG242 are connected to each other by a connection point which is used as a third input node TI241 of the second OAMP 240.

The current source I241, the gate of the PMOS transistor PT242 and the other input/output node T243 of the transmission gate TMG242 are connected to each other by a connection point which is used as a fourth input node TI242 of the second OAMP 240.

In the transmission gate TMG242, the gate of a PMOS transistor PT244 receives the third bias signal BIASL1 whereas the gate of an NMOS transistor NT243 receives the fourth bias signal BIASL2.

The third bias signal BIASL1 and the fourth bias signal BIASL2 are applied to the gate of the PMOS transistor PT244 and the gate of the NMOS transistor NT243 respectively to serve as voltages which are used for setting a DC current flowing to the third output amplifier 241 employed in the second OAMP 240 provided at the output stage.

In the present embodiment, the switch SW245 is provided between the third input node TI241 of the second OAMP 240 and the gate of the PMOS transistor PT242. To put it in detail, a node a of the switch SW245 is connected to the third input node TI241 whereas a node b of the switch SW245 is connected to the gate of the PMOS transistor PT242.

The switch SW246 is provided between the other input/output node T244 of the transmission gate TMG242 and the gate of the NMOS transistor NT242. To put it in detail, a node a of the switch SW246 is connected to the other input/output node T244 whereas a node b of the switch SW246 is connected to the gate of the NMOS transistor NT242.

The switch SW247 is provided between the gate of the PMOS transistor PT242 and the source for supplying the power-supply voltage VDD. To put it in detail, a node a of the switch SW247 is connected to the gate of the PMOS transistor PT242 whereas a node b of the switch SW247 is connected to the source for supplying the power-supply voltage VDD.

The switch SW248 is provided between the gate of the NMOS transistor NT242 and the ground GND. To put it in detail, a node a of the switch SW248 is connected to the ground GND whereas a node b of the switch SW248 is connected to the gate of the NMOS transistor NT242.

In the second OAMP 240, the switches SW243, SW244, SW245 and SW246 are controlled to enter a turned-on state or a turned-off state by the common switch-state changeover control signal STR described earlier.

On the other hand, the switches SW241, SW242, SW247 and SW248 are controlled to enter a turned-on state or a turned-off state by the common switch-state changeover control signal CRS described earlier.

The switches SW241, SW242, SW247 and SW248 are put in a turned-on state or a turned-off state by the common switch-state changeover control signal CRS complementarily to the switches SW243, SW244, SW245 and SW246. Conversely, the switches SW243, SW244, SW245 and SW246 are put in a turned-on state or a turned-off state by the common switch-state changeover control signal STR complementarily to the switches SW241, SW242, SW247 and SW248.

That is to say, a control system shown in none of the figures executes such control that, when the common switch-state changeover control signal STR is set at a high level, the common switch-state changeover control signal CRS is set at a low level and, when the common switch-state changeover control signal STR is set at a low level, the common switch-state changeover control signal CRS is set at a high level.

For example, when the common switch-state changeover control signal STR is set at a high level, the switches SW243, SW244, SW245 and SW246 are put in a turned-on state. When the common switch-state changeover control signal STR is set at a low level, on the other hand, the switches SW243, SW244, SW245 and SW246 are put in a turned-off state.

By the same token, when the common switch-state changeover control signal CRS is set at a high level, the switches SW241, SW242, SW247 and SW248 are put in a turned-on state. When the common switch-state changeover control signal CRS is set at a low level, on the other hand, the switches SW241, SW242, SW247 and SW248 are put in a turned-off state.

In the typical configuration of the buffer/amplifier section 200 shown in the circuit diagram of FIG. 7, the common switch-state changeover control signal STR is set at a high level whereas the common switch-state changeover control signal CRS is set at a low level.

Thus, the switches SW241, SW242, SW247 and SW248 are put in a turned-off state whereas the switches SW243, SW244, SW245 and SW246 are put in a turned-on state.

In this typical state of the configuration, in the fourth output amplifier 242 shown in the circuit diagram of FIG. 9, a negative-polarity signal voltage output by the negative-polarity OTA 230 is supplied to the gate of the PMOS transistor PT242 by way of the switch SW245 and the gate of the NMOS transistor NT242 by way of the switch SW246, being amplified into an output signal.

In the third output amplifier 241, on the other hand, the gate of the PMOS transistor PT241 is sustained at the level of the power-supply voltage VDD whereas the gate of the NMOS transistor NT241 is sustained at the level of the electric potential of the ground GND. As a result, each of the PMOS transistor PT241 and the NMOS transistor NT241 is sustained in a turned-off state with a high degree of reliability so that the flow of a penetration current is avoided.

As described above by referring to the circuit diagram of FIG. 8, the positive-polarity OTA 210 is configured to function as a differential amplifier employing the N-channel MOS transistors NT211 and NT212 whereas the negative-polarity OTA 230 is configured to function as a differential amplifier employing the P-channel MOS transistors PT231 and PT232.

Each of the first OAMP 220 and the second OAMP 240 each serving as an output buffer carries out an AB-class push-pull operation. There is a difference in operating point between the positive-polarity signal voltage output by the positive-polarity OTA 210 and the negative-polarity signal voltage output by the negative-polarity OTA 230.

For this reason, the positive-polarity signal voltage and the negative-polarity signal which are output by the positive-polarity OTA 210 and the negative-polarity OTA 230 respectively are supplied to the first OAMP 220 provided at the output stage by way of 2 separate nodes respectively in operations to be described below. By the same token, the positive-polarity signal voltage and the negative-polarity signal which are output by the positive-polarity OTA 210 and the negative-polarity OTA 230 respectively are supplied to the second OAMP 240 provided at the output stage by way of 2 separate nodes respectively.

Next, by referring to the circuit diagrams of FIGS. 8 and 9 as well as a timing diagram of FIGS. 10A to 10F, the following description explains operations carried out by the buffer/amplifier section 127 (that is, the buffer/amplifier section 200) employed in the signal-line driving circuit 120 according to the present embodiment. As described before, in the block diagram of FIG. 6, the buffer/amplifier section 200 shown in the block diagram of FIG. 7 is denoted by reference numeral 127.

FIGS. 10A to 10F are timing diagrams showing a plurality of timing charts to be referred to in explanation of the operations carried out by the buffer/amplifier section 200 according to the present embodiment. To be more specific, FIG. 10A shows a timing chart of the switch-state changeover control signal STR whereas FIG. 10B shows a timing chart of the switch-state changeover control signal CRS. FIG. 10C shows a timing chart of the level of a signal DACUOUT1 output by a DAC employed in the selector section 126 shown in the block diagram of FIG. 6 whereas. FIG. 10D shows a timing chart of the level of a signal DACUOUT2 output by another DAC employed in the selector section 126.

FIG. 10E shows a timing chart of a signal output for the channel CH1 whereas FIG. 10F shows a timing chart of a signal output for the channel CH2.

Unlike the existing configuration shown in the block diagram of FIG. 3 as a configuration adopting the traditional output selector method, in the buffer/amplifier section 200 according to the present embodiment, the switches SW251 to SW254 are provided at a stage preceding the input nodes of the first OAMP 220 and the second OAMP 240 which are provided at the output stage. The switches SW251 and SW252 are used for supplying the positive-polarity signal voltage output by the positive-polarity OTA 210 for the channel CH1 to the first OAMP 220 and for the channel CH2 to the second OAMP 240 respectively. By the same token, the switches SW253 and SW254 are used for supplying the negative-polarity signal voltage output by the negative-polarity OTA 230 for the channel CH2 to the second OAMP 240 and for the channel CH1 to the first OAMP 220 respectively. The positive-polarity signal voltage output for the channel CH1 but supplied to the second OAMP 240 by way of the switch SW252 complements the negative-polarity signal voltage output for the channel CH2 and supplied to the second OAMP 240 by way of the switch SW253. On the other hand, the negative-polarity signal voltage output for the channel CH2 but supplied to the first OAMP 220 by way of the switch SW254 complements the positive-polarity signal voltage output for the channel CH1 and supplied to the first OAMP 220 by way of the switch SW251.

On the other hand, the switch SW255 is provided on a feedback path from the output node of the first OAMP 220 to a specific (non-inverting) input node of the positive-polarity OTA 210, the switch SW256 is provided on a feedback path from the output node of the second OAMP 240 to the specific input node of the positive-polarity OTA 210, the switch SW257 is provided on a feedback path from the output node of the second OAMP 240 to a particular (non-inverting) input node of the negative-polarity OTA 230 and the switch SW258 is provided on a feedback path from the output node of the first OAMP 220 to the particular input node of the negative-polarity OTA 230. A signal fed-back from the output node of the second OAMP 240 to the specific input node of the positive-polarity OTA 210 by way of the switch SW256 complements a signal fed-back from the output node of the first OAMP 220 to the specific input node of the positive-polarity OTA 210 by way of the switch SW255. By the same token, a signal fed-back from the output node of the first OAMP 220 to the particular input node of the negative-polarity OTA 230 by way of the switch SW258 complements a signal fed-back from the output node of the second OAMP 240 to the particular input node of the negative-polarity OTA 230 by way of the switch SW257.

In the configuration described above, in a first mode where the common switch-state changeover control signal STR is sustained at a high level and the common switch-state changeover control signal CRS is sustained at a low level, the following operations are carried out.

Each of the switches SW251, SW253, SW255 and SW257 is sustained in a turned-on state whereas each of the switches SW252, SW254, SW256 and SW258 is sustained in a turned-off state.

Thus, a positive-polarity signal voltage generated by the positive-polarity OTA 210 is supplied to the first output amplifier 221 employed in the first OAMP 220 by way of the first input node TI221.

In addition, a negative-polarity signal voltage generated by the negative-polarity OTA 230 is supplied to the third output amplifier 241 employed in the second OAMP 240 by way of the third input node TI241.

The first output amplifier 221 employed in the first OAMP 220 amplifies the signal voltage with the positive polarity by making use of the power-supply voltage VDD and the intermediate reference voltage VSS2 as 2 operating voltages which serve respectively as the upper and lower limits of a voltage range. The amplitude of the amplified signal voltage at the amplification time is about VDD/2. The first output amplifier 221 applies the amplified signal voltage to the first signal line 112m by way of the output node TO221 and the output node TO1.

By the same token, the third output amplifier 241 employed in the second OAMP 240 amplifies the signal voltage with the negative polarity by making use of the intermediate power-supply voltage VDD2 and the reference voltage VSS (that is, the electric potential of the ground GND) as 2 operating voltages which serve respectively as the upper and lower limits of another voltage range. The amplitude of the amplified signal voltage at the amplification time is also about VDD/2. The third output amplifier 241 applies the amplified signal voltage to the second signal line 112m+1 by way of the output node TO241 and the output node TO2.

In a second mode where the common switch-state changeover control signal STR is sustained at a low level and the common switch-state changeover control signal CRS is sustained at a high level, on the other hand, the following operations are carried out.

Each of the switches SW251, SW253, SW255 and SW257 is sustained in a turned-off state whereas each of the switches SW252, SW254, SW256 and SW258 is sustained in a turned-on state.

Thus, a positive-polarity signal voltage generated by the positive-polarity OTA 210 is supplied to the fourth output amplifier 242 employed in the second OAMP 240 by way of the fourth input node TI242.

In addition, a negative-polarity signal voltage generated by the negative-polarity OTA 230 is supplied to the second output amplifier 222 employed in the first OAMP 220 by way of the second input node TI222.

The second output amplifier 222 employed in the first OAMP 220 amplifies the signal voltage with the negative polarity by making use of the intermediate power-supply voltage VDD2 and the reference voltage VSS (that is, the electric potential of the ground GND) as 2 operating voltages which serve respectively as the upper and lower limits of the other voltage range cited above. The amplitude of the amplified signal voltage at the amplification time is about VDD/2. The second output amplifier 222 applies the amplified signal voltage to the first signal line 112m by way of the output node TO221 and the output node TO1.

By the same token, the fourth output amplifier 242 employed in the second OAMP 240 amplifies the signal voltage with the positive polarity by making use of the power-supply voltage VDD and the intermediate reference voltage VSS2 as 2 operating voltages which serve respectively as the upper and lower limits of the voltage range mentioned above. The amplitude of the amplified signal voltage at the amplification time is about VDD/2. The fourth output amplifier 242 applies the amplified signal voltage to the second signal line 112m+1 by way of the output node TO241 and the output node TO2.

As described above, unlike the existing configuration shown in the block diagram of FIG. 3 as a configuration adopting the traditional output selector method, in each of the first OAMP 220 and the second OAMP 240 which are employed in the buffer/amplifier section 200 according to the present embodiment, the power-supply voltage VDD and the intermediate reference voltage VSS2 are used as 2 operating voltages serving respectively as the upper and lower limits of the voltage range mentioned above whereas the intermediate power-supply voltage VDD2 and the reference voltage VSS are used as 2 operating voltages which serve respectively as the upper and lower limits of the other voltage range. That is to say, the type of the operating voltages can be one of 2 voltage-pair types. One of the 2 voltage-pair types is the power-supply voltage VDD and the intermediate reference voltage SS2 (.VDD/2) whereas the other voltage-pair type is the intermediate power-supply voltage VDD2 (.VDD/2) and the reference voltage VSS which is for example the electric potential of the ground GND.

In addition, the switches SW251 to SW254 provided at a stage preceding the output stage are used for supplying signals from the positive-polarity OTA 210 and the negative-polarity OTA 230 for the channels CH1 and CH2 to the first OAMP 220 and the second OAMP 240 complementarily to each other. On top of that, the switches SW255 to SW258 provided on the feedback paths from the first OAMP 220 and the second OAMP 240 to the positive-polarity OTA 210 and the negative-polarity OTA 230 are used for feeding back signals output by the first OAMP 220 and the second OAMP 240 to the positive-polarity OTA 210 and the negative-polarity OTA 230 complementarily to each other.

Since circuits driven by different power-supply voltages adapted to voltages to be output are used in the buffer/amplifier section 200 in accordance with the present embodiment as described above, it is possible to reduce the power consumption of the buffer/amplifier section 200 and to improve the characteristics of the buffer/amplifier section 200.

A mechanism of reduction of the power consumption of the signal-line driving circuit 120 according to the present embodiment is described as follows.

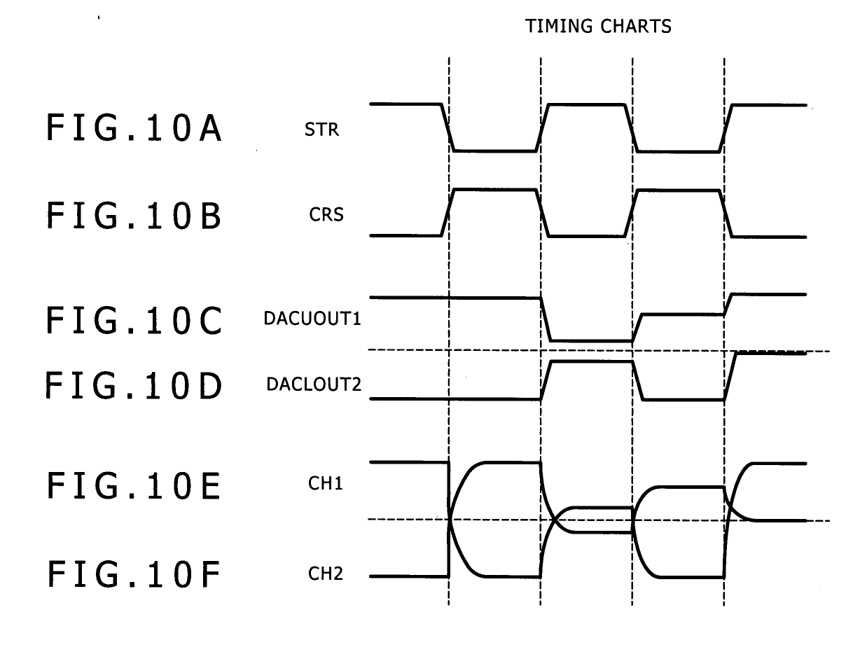

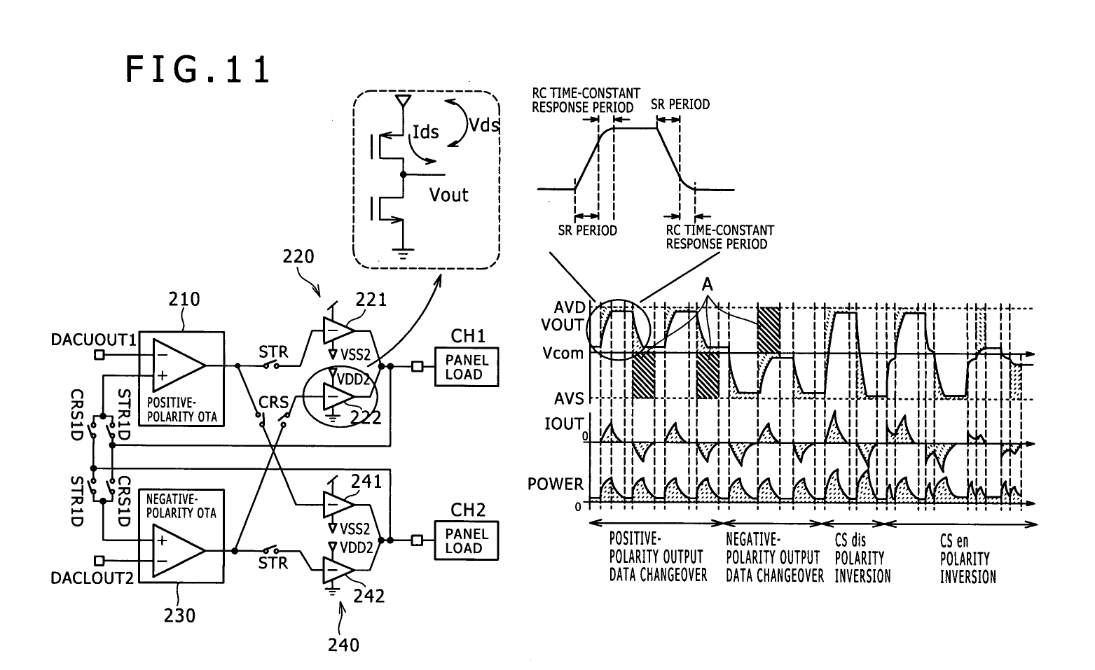

FIG. 11 is an explanatory diagram showing a mechanism for reducing the power consumption of the signal-line driving circuit 120.

It is to be noted that, in the following description, each of the first OAMP 220 and the second OAMP 240 is explained as a transistor provided at the output stage.

During 1 period T, the power consumed by the transistor provided at the output stage is expressed by the following equation.

$$POWER ( t ) = \frac{1}{T} {\int }_{0}^{T} ( Vds ( t ) * I d s ( t ) ) d t \qquad ( 1 )$$

In the above equation, reference notation Vds denotes a difference between the source voltage of the transistor and the output (drain) voltage of the transistor whereas reference notation Ids denotes the drain current of the output transistor. The drain current of the transistor is a current output by the transistor.

The output current of the transistor is expressed by Eqs. (2) and (3) which are given respectively for the sub-period 0(s) to t1(s) and the sub-period t1(s) to T(s) within 1 period T as follows:

$$\begin{matrix}Iout ( t ) = ( SR ) C ( 1 - {e}^{- \frac{t}{RC}} ) \\ ( 0 [ s ] - t 1 [ s ] ) & ( 2 ) \\ Iout ( t ) = - \frac{{V}_{0} - Vtarget}{R} {e}^{- \frac{t - t 1}{RC}} \\ ( t 1 [ s ] - T [ s ] ) & ( 3 )\end{matrix}$$

In the above equations, reference notation SR denotes the through rate of the amplifier OPAMP, reference notation R denotes a total of output load resistances including the resistance of a panel load, reference notation R1 denotes the output resistance of the amplifier OPAMP and reference notation C denotes the capacitance of the output loads.

As shown by the equations given above, the output current Iout is not dependent on the voltage of the power supply. Instead, the output current Iout is a function of output-signal amplitude, external loads and OPAMP internal through rate SR.

In the above equations, reference notation V0 denotes an initial output voltage which appears after a though-rate operation has been carried out whereas reference notation t1 denotes the end of the period 0(s) to t1(s) during which the though-rate operation is carried out.

As shown in a current waveform diagram of FIG. 11, Eq. (2) dominates an effect on the power of the output current Iout.

Eq. (4) given below is an equation expressing the voltage difference Vds output by the transistor during a through-rate response period whereas Eq. (5) given below is an equation expressing the voltage difference Vds output by the output transistor during a period of giving a response at a time constant RC.

In these equations, reference notation Vtarget denotes a final target electric potential, reference notation R1 denotes the resistance of an output path in the chip and reference notation Vs denotes the source voltage of the output transistor.

$$\begin{matrix}{V}_{ds} ( t ) = Vs - \{ SR \cdot t - SR \cdot {R}_{1} \cdot C ( 1 - {e}^{- \frac{t}{RC}} ) \} & ( 4 ) \\ {V}_{ds} ( t ) = Vs - \{ {V}_{target} - \frac{{R}_{1}}{R} ( {V}_{target} - {V}_{0} ) {e}^{- \frac{t - t 1}{RC}} \} & ( 5 )\end{matrix}$$

Eqs. (4a) and (5a) given below as equations each expressing the voltage difference Vds are equations to be compared with above Eqs. (4) and (5) respectively. Eqs. (4a) and (5a) are Eqs. (4) and (5) respectively for Vs=VDD.

$$\begin{matrix}{V}_{ds} ( t ) = VDD - SR \cdot t + SR \cdot {R}_{1} \cdot C ( 1 - {e}^{- \frac{t}{RC}} ) & ( 4 a ) \\ {V}_{ds} ( t ) = VDD - {V}_{target} - \frac{{R}_{1}}{R} ( {V}_{target} - {V}_{0} ) {e}^{- \frac{t - t 1}{RC}} & ( 5 a )\end{matrix}$$

By the same token, Eqs. (4b) and (5b) given below as equations each expressing the voltage difference Vds are equations to be compared with above Eqs. (4) and (5) respectively. Eqs. (4b) and (5b) are Eqs. (4) and (5) respectively for Vs=VDD/2.

$$\begin{matrix}{V}_{ds} ( t ) = \frac{VDD}{2} - SR \cdot t + SR \cdot {R}_{1} \cdot C ( 1 - {e}^{- \frac{t}{RC}} ) & ( 4 b ) \\ {V}_{ds} ( t ) = \frac{VDD}{2} - {V}_{target} - \frac{{R}_{1}}{R} ( {V}_{target} - {V}_{0} ) {e}^{- \frac{t - t 1}{RC}} & ( 5 b )\end{matrix}$$

As described above, the output current Iout is not dependent on the voltage of the power supply. However, the voltage difference Vds is reduced by VDD/2.

The final target electric potential Vtarget and the initial output voltage V0 appearing after a though-rate operation are also not dependent on the voltage of the power supply.

Since the output current Iout is not dependent on the voltage of the power supply, there is a Vds reduction effect for a hatched area A shown in the diagram of FIG. 11.

In particular, if a data changeover is implemented at a large amplitude without inverting the polarity, a power reduction effect increases.

In addition, in accordance with the method provided by the present embodiment, no switches are demanded at the output stage. Thus, the impedance of the output path can be decreased.

As a result, currents for electrically charging the loads are supplied to the loads without flowing through the conductive-state resistance of the switches that are provided at the output stage of the existing configuration. Accordingly, the power that would otherwise be consumed by such switches can be reduced to zero. The magnitude of such power is determined by the output current Iout and the conductive-state resistances of such switches.

### 3: Modified Versions

The rail-to-rail method cannot be adopted for the existing circuit configurations.

However, the rail-to-rail method can be adopted as a method of the present embodiment.

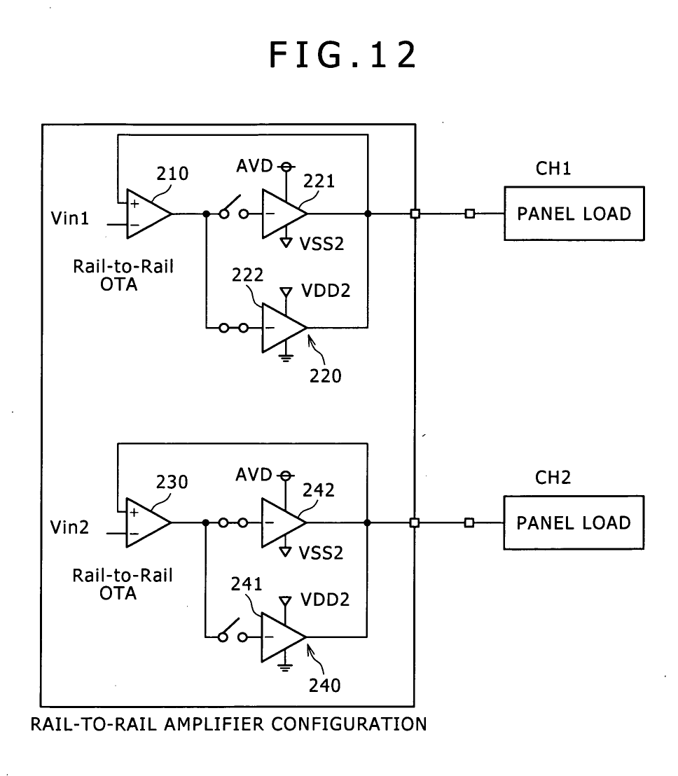

FIG. 12 is a circuit diagram referred to in explanation of the rail-to-rail method adopted by the buffer/amplifier section 200.

With adoption of the existing method, a rush current flows at a polarity inversion time. Thus, there is a concern that the EMI characteristic deteriorates due to the rush current.

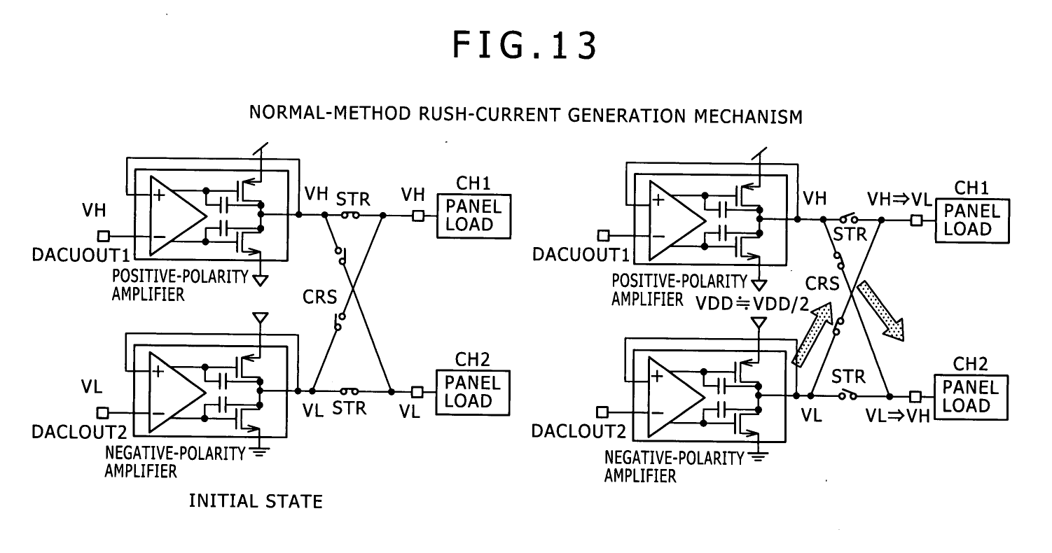

FIG. 13 is a circuit diagram referred to in explaining the principle of generation of a rush current.

Let us assume for example that, in a changeover from a state established by a negative-polarity OTA to a positive-polarity side for a certain channel, the voltage appearing at the output node abruptly changes from VL to VH.

At this instant, with adoption of the existing method, the abrupt change of the voltage appearing at the output node propagates to the voltage appearing at the gate of an output-stage transistor through a parasitic capacitor existing between the drain and gate of the transistor or a phase compensation capacitor. At that time, a voltage lower than the lower limit of the normal operating range is applied instantaneously to the output node of the positive-polarity OTA. Thus, the difference between the voltage applied to the output node of the positive-polarity OTA and a voltage supplied to the input node of the positive-polarity OTA is large. As a result, a large rush current is flowing to the output node of the positive-polarity OTA till the voltage applied to the output node of the positive-polarity OTA reaches a level in the normal operating range.

In order to solve this rush-current problem raised by the existing method, the method is improved by taking a typical countermeasure of shifting the polarity inversion timing from channel to channel. Basically, however, there has not been found a solution to the problem.

In the case of the method according to the present embodiment, on the other hand, the output path is not changed from one to another. Thus, unlike the existing method, the rush current hardly flows. As a result, it is possible to adopt a changeover technique which is implemented by putting the gate of the transistor provided at the output stage in a turned-off state.

As described above, in accordance with the present embodiment, the following effects can be demonstrated.

Since circuits driven by different power-supply voltages adapted to voltages to be output are used in the signal-line driving circuit according to the present embodiment, it is possible to reduce the power consumption of the signal-line driving circuit and to improve the characteristics of the signal-line driving circuit.

Since the power consumption of the signal-line driving circuit decreases, the number of channels in the signal-line driving circuit according to the present embodiment can be increased.

Since the power consumption per unit area in the signal-line driving circuit decreases, it is not necessary to take a countermeasure against the effect of heat dissipated by an IC which implements the present embodiment. Thus, the cost of the signal-line driving circuit according to the present embodiment can be reduced.

Since the output path of the signal-line driving circuit according to the present embodiment does not include a switch, the size of the signal-line driving circuit can be reduced. As a result, the layout area of the signal-line driving circuit can be decreased.

Since the output path of the signal-line driving circuit according to the present embodiment does not include a switch, the settling characteristic can be improved. As a result, the overall characteristic of the signal-line driving circuit according to the present embodiment can also be improved as well.

Since the output path of the signal-line driving circuit according to the present embodiment does not include a switch, that is, since changeover switches are embedded into the amplifier circuit, the switch size can be reduced. Also in this case, the layout area of the signal-line driving circuit can be decreased.

Since the output path of the signal-line driving circuit according to the present embodiment does not include a switch, the rush current is not generated in the signal-line driving circuit. Thus, the EMI characteristic of the signal-line driving circuit can be improved.

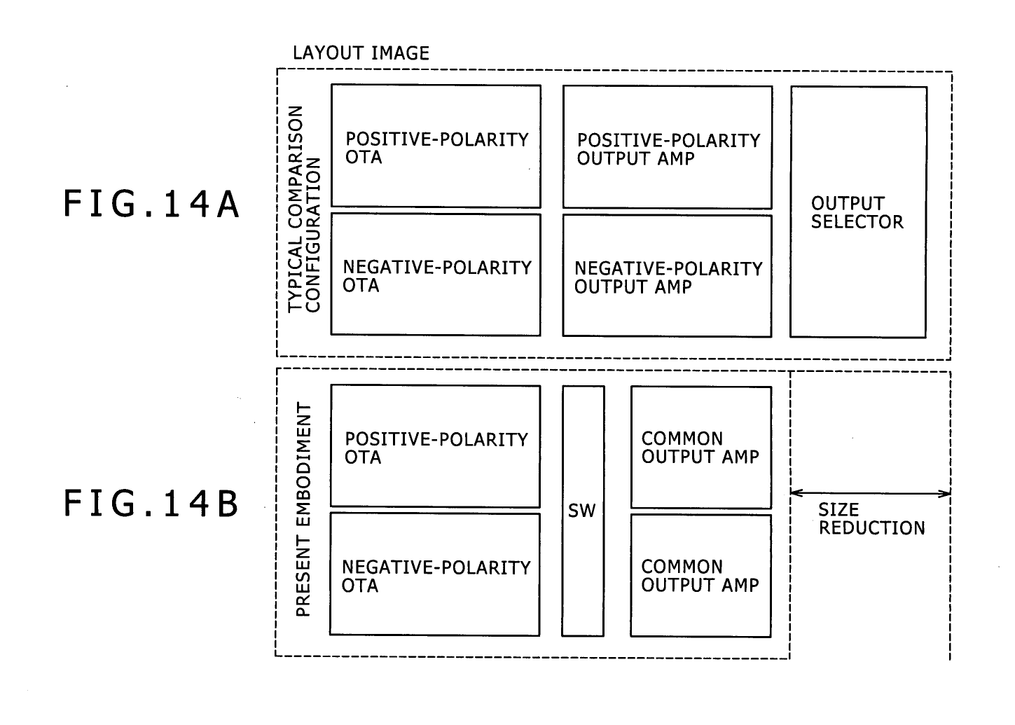

FIGS. 14A and 14B are a plurality of explanatory diagrams referred to in comparison of the layout image of the existing output buffer section serving as a typical comparison configuration adopting the traditional output selector method with the layout image of the buffer/amplifier section 200 according to the present embodiment. To be more specific, FIG. 14A is an explanatory diagram showing the layout image of the typical comparison configuration whereas FIG. 14B is an explanatory diagram showing the layout image of the buffer/amplifier section 200 according to the present embodiment.

The size of switches (SW) shown in the explanatory diagram of FIG. 14B can be reduced. This is because the switches are not connected to the output paths of the buffer/amplifier section 200 according to the present embodiment so that it is not necessary to reduce the conductive-state resistances of the switches and, thus, unnecessary to increase the size of the switches.

In addition, the device sizes of the first OAMP 220 and the second OAMP 240 can also be reduced as well. This is because there are no switches (SW) connected in series thereto.

As described above, the present embodiment implements a liquid-crystal display apparatus of the active-matrix type as an example. It is to be noted, however, that the scope of the present invention is by no means limited to the present embodiment. For example, the present invention can also be applied as well in the same way to an active-matrix liquid-crystal display apparatus of another kind. A typical example of the active-matrix liquid-crystal display apparatus of another kind is an EL (Electro Luminescence) display apparatus which employs an EL device in every pixel to serve as an electro-optical device.

### 4: Typical Electronic Apparatus

On top of that, active-matrix liquid-crystal display apparatus represented by the active-matrix liquid-crystal display apparatus according to the present embodiment can be applied to a variety of electronic apparatus which are described below.

That is to say, the liquid-crystal display apparatus of the active-matrix type can be used as an image display apparatus employed in an electronic apparatus designed for all fields in which a video signal supplied to the electronic apparatus employing the liquid-crystal display apparatus or a video signal generated in the electronic apparatus is displayed as an image or a video picture.

Typical examples of the electronic apparatus are a TV, a digital camera, a notebook personal computer, a portable terminal apparatus (or a mobile apparatus) such as a cellular phone, a desktop personal computer and a video camera.

The following description explains typical electronic apparatus which each employ the active-matrix liquid-crystal display apparatus according to the present embodiment.

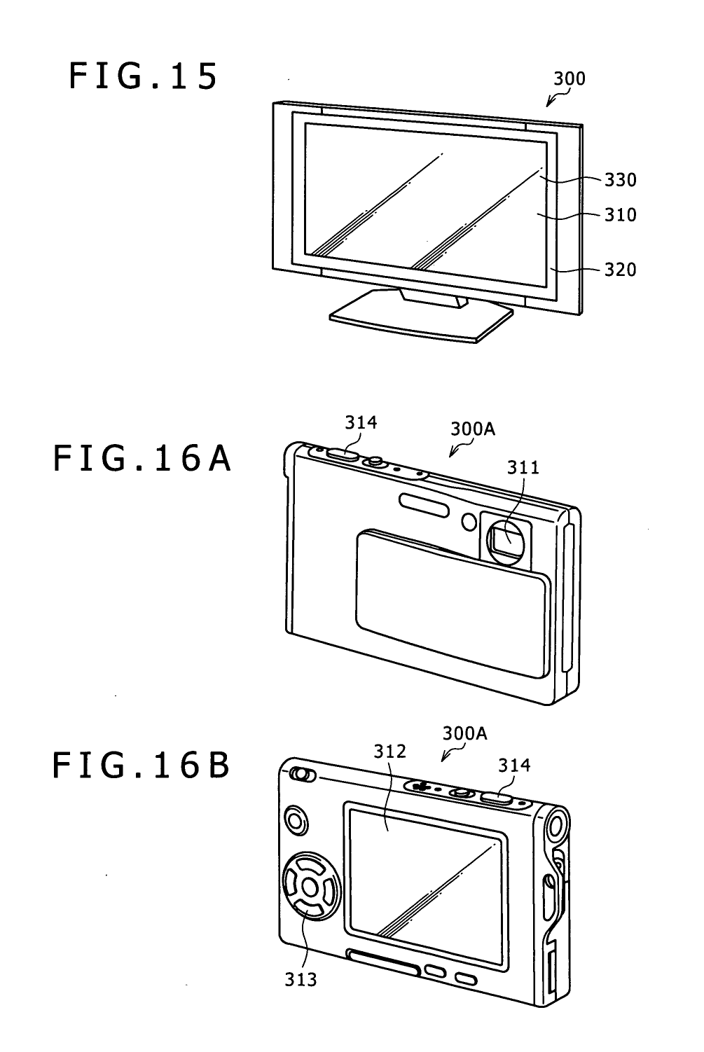

FIG. 15 is a diagram showing a perspective view of a TV 300 which serves as an electronic apparatus employing the active-matrix liquid-crystal display apparatus according to the present embodiment.

As shown in the figure, the TV 300 serving as an electronic apparatus employing the active-matrix liquid-crystal display apparatus according to the present embodiment has an image display screen section 310 which is configured to make use of a front panel 320 and a filter glass plane 330. In the case of the TV 300, it is the image display screen section 310 that serves as the active-matrix liquid-crystal display apparatus according to the present embodiment.

FIGS. 16A and 16B are a plurality of diagrams each showing a perspective view of a digital camera 300A which serves as an electronic apparatus employing the active-matrix liquid-crystal display apparatus according to the present embodiment. To be more specific, FIG. 16A is a diagram showing a perspective front view of the digital camera 300A whereas FIG. 16B is a diagram showing a perspective rear view of the digital camera 300A.

As shown in the figure, the digital camera 300A serving as an electronic apparatus employing the active-matrix liquid-crystal display apparatus according to the present embodiment has a light emitting section 311 for flashing light, a display section 312, a menu switch 313 and a shutter button 314. In the case of the digital camera 300A, it is the display section 312 that serves as the active-matrix liquid-crystal display apparatus according to the present embodiment.

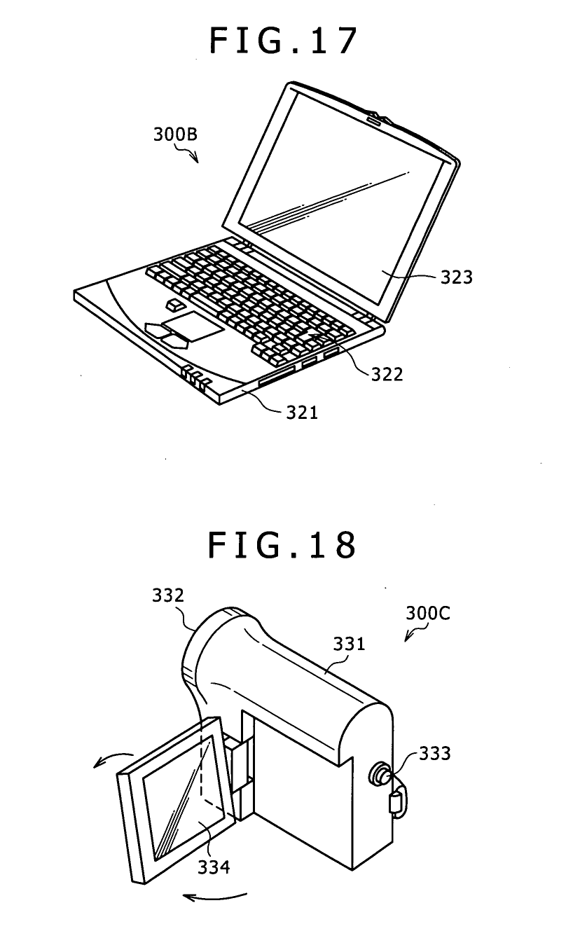

FIG. 17 is a diagram showing a perspective view of a notebook personal computer 300B which serves as an electronic apparatus employing the active-matrix liquid-crystal display apparatus according to the present embodiment.

As shown in the figure, the notebook personal computer 300B serving as an electronic apparatus employing the active-matrix liquid-crystal display apparatus according to the present embodiment has a main body 321, a keyboard 322 to be operated by the user to enter characters or the like and a display section 323 for displaying an image. In the case of the notebook personal computer 300B, it is the display section 323 that serves as the active-matrix liquid-crystal display apparatus according to the present embodiment.

FIG. 18 is a diagram showing a perspective view of a video camera 300C which serves as an electronic apparatus employing the active-matrix liquid-crystal display apparatus according to the present embodiment.

As shown in the figure, the video camera 300C serving as an electronic apparatus employing the active-matrix liquid-crystal display apparatus according to the present embodiment has a main body 331, a lens 332, a start/stop switch 333 and a display section 334. The lens 332 for taking a picture of a subject of photographing is provided on a face which is oriented in the forward direction. The start/stop switch 333 is operated in a photographing operation which is carried out to take a picture of the subject of photographing. In the case of the video camera 300C, it is the display section 334 that serves as the active-matrix liquid-crystal display apparatus according to the present embodiment.

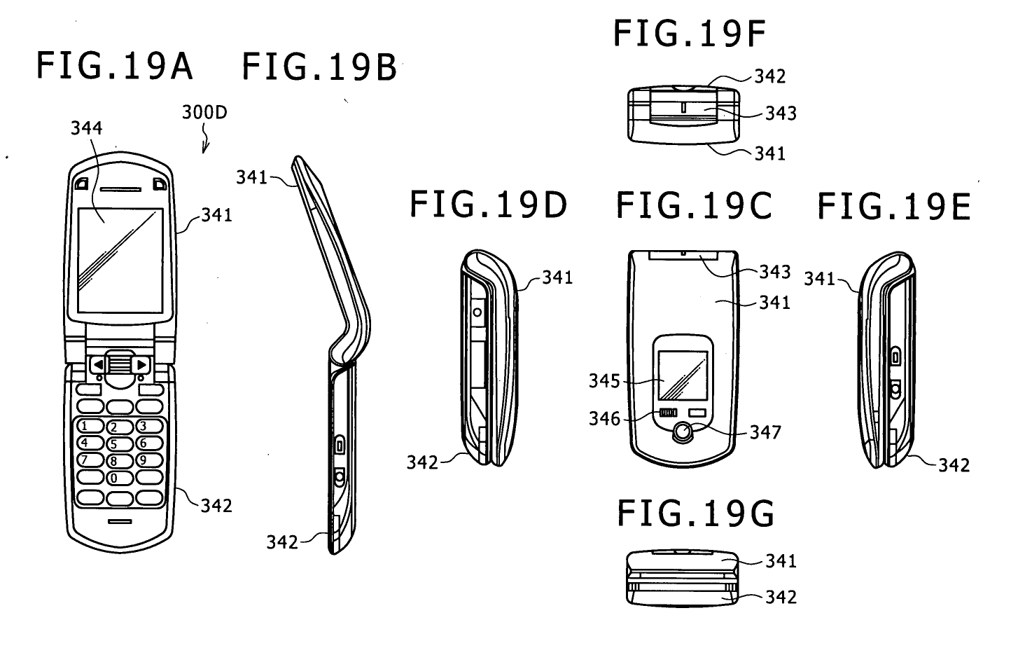

FIGS. 19A to 19G are a plurality of diagrams each showing a view of a portable terminal apparatus such as a cellular phone 300D which serves as an electronic apparatus employing the active-matrix liquid-crystal display apparatus according to the present embodiment. To be more specific, FIG. 19A is a diagram showing a front view of the cellular phone 300D in an opened state whereas FIG. 19B is a diagram showing a side view of the cellular phone 300D in the opened state. FIG. 19C is a diagram showing a top view of the cellular phone 300D in a closed state. FIG. 19D is a diagram showing a left-hand side view of the cellular phone 300D in the closed state whereas FIG. 19E is a diagram showing a right-hand side view of the cellular phone 300D in the closed state. FIG. 19F is a diagram showing a front view of the cellular phone 300D in the closed state whereas FIG. 19G is a diagram showing a rear view of the cellular phone 300D in the closed state.

As shown in the figure, the cellular phone 300D serving as an electronic apparatus employing the active-matrix liquid-crystal display apparatus according to the present embodiment has an upper-side cabinet 341, a lower-side cabinet 342, a hinge serving as a joint section 343, a display section 344, a sub-display section 345, a picture light section 346 and a camera 347. In the case of the cellular phone 300D, it is each of the display section 344 and the sub-display section 345 that serves as the active-matrix liquid-crystal display apparatus according to the present embodiment.

The present application contains subject matter related to that disclosed in Japanese Priority Patent Application JP 2009-151423 filed in the Japan Patent Office on Jun. 25, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal-line driving circuit comprising an output buffer section configured to amplify input data for driving signal lines in order to generate a positive-polarity signal voltage as well as a negative-polarity signal voltage and selectively supplying said positive-polarity signal voltage as well as said negative-polarity signal voltage to a signal-line pair composing of a first one of said signal lines and a second one of said signal lines, wherein
said output buffer section employs:
a positive-polarity operational transconductance amplifier configured to amplify said input data in order to generate said positive-polarity signal voltage;
a negative-polarity operational transconductance amplifier configured to amplify said input data in order to generate said negative-polarity signal voltage;
a first output section configured to supply said positive-polarity signal voltage or said negative-polarity signal voltage to said first signal line;
a second output section configured to supply said positive-polarity signal voltage or said negative-polarity signal voltage to said second signal line; and
a group of switches which are provided respectively on a forward path between the output node of said positive-polarity operational transconductance amplifier and an input node of said first output section, on a forward path between said output node of said positive-polarity operational transconductance amplifier and an input node of said second output section, on a forward path between the output node of said negative-polarity operational transconductance amplifier and another input node of said second output section, on a forward path between said output node of said negative-polarity operational transconductance amplifier and another input node of said first output section, on a feedback path between the output node of said first output section and a specific input node of said positive-polarity operational transconductance amplifier, on a feedback path between the output node of said second output section and said specific input node of said positive-polarity operational transconductance amplifier, on a feedback path between said output node of said second output section and a particular input node of said negative-polarity operational transconductance amplifier and on a feedback path between said output node of said first output section and said particular input node of said negative-polarity operational transconductance amplifier,
each of said first output section and said second output section carries out a process on said positive-polarity signal voltage generated by said positive-polarity operational transconductance amplifier and selectively supplied to said first and second output sections by said group of switches in a voltage range between a power-supply voltage and an intermediate reference voltage set between said power-supply voltage and a reference voltage, outputting a result of said process, and
each of said first output section and said second output section carries out another process on said negative-polarity signal voltage generated by said negative-polarity operational transconductance amplifier and selectively supplied to said first and second output sections by said group of switches in another voltage range between said reference voltage and an intermediate power-supply voltage set between said power-supply voltage and said reference voltage, outputting a result of said other process.

2. The signal-line driving circuit according to claim 1 wherein:
in a first mode, said group of switches
supplies said positive-polarity signal voltage generated by said positive-polarity operational transconductance amplifier to said first output section and feeds a signal output by said first output section back to said positive-polarity operational transconductance amplifier, and
supplies said negative-polarity signal voltage generated by said negative-polarity operational transconductance amplifier to said second output section and feeds a signal output by said second output section back to said negative-polarity operational transconductance amplifier; whereas
in a second mode, said group of switches
supplies said positive-polarity signal voltage generated by said positive-polarity operational transconductance amplifier to said second output section and feeds a signal output by said second output section back to said positive-polarity operational transconductance amplifier, and
supplies said negative-polarity signal voltage generated by said negative-polarity operational transconductance amplifier to said first output section and feeds a signal output by said first output section back to said negative-polarity operational transconductance amplifier.

3. The signal-line driving circuit according to claim 2 wherein:
said first output section includes
a first output amplifier operating in said voltage range between said power-supply voltage and said intermediate reference voltage set between said power-supply voltage and said reference voltage to serve as an output amplifier for amplifying said positive-polarity signal voltage generated by said positive-polarity operational transconductance amplifier and selectively supplied to said first output section by said group of switches before outputting said positive-polarity signal voltage to said first signal line, and
a second output, amplifier operating in said other voltage range between said reference voltage and said intermediate power-supply voltage set between said power-supply voltage and said reference voltage to serve as an output amplifier for amplifying said negative-polarity signal voltage generated by said negative-polarity operational transconductance amplifier and selectively supplied to said first output section by said group of switches before outputting said negative-polarity signal voltage to said first signal line; whereas
said second output section includes
a third output amplifier operating in said other voltage range between said reference voltage and said intermediate power-supply voltage set between said power-supply voltage and said reference voltage to serve as an output amplifier for amplifying said negative-polarity signal voltage generated by said negative-polarity operational transconductance amplifier and selectively supplied to said second output section by said group of switches before outputting said negative-polarity signal voltage to said second signal line, and
a fourth output amplifier operating in said voltage range between said power-supply voltage and said intermediate reference voltage set between said power-supply voltage and said reference voltage to serve as an output amplifier for amplifying said positive-polarity signal voltage generated by said positive-polarity operational transconductance amplifier and selectively supplied to said second output section by said group of switches before outputting said positive-polarity signal voltage to said second signal line.

4. The signal-line driving circuit according to claim 3 wherein:
said first output section has a first input node and a second input node;
said second output section has a third input node and a fourth input node;
in said first mode,
said positive-polarity signal voltage generated by said positive-polarity operational transconductance amplifier is supplied to said first output amplifier of said first output section by way of said first input node, and
said negative-polarity signal voltage generated by said negative-polarity operational transconductance amplifier is supplied to said third output amplifier of said second output section by way of said third input node; whereas
in said second mode
said positive-polarity signal voltage generated by said positive-polarity operational transconductance amplifier is supplied to said fourth output amplifier of said second output section by way of said fourth input node, and
said negative-polarity signal voltage generated by said negative-polarity operational transconductance amplifier is supplied to said second output amplifier of first output section by way of said second input node.

5. The signal-line driving circuit according to claim 1 wherein the level of said intermediate reference voltage is about equal to the level of said intermediate power-supply voltage.

6. A display apparatus comprising:
a display section on which display cells driven by adoption of a polarity inversion driving method are laid out to form a cell matrix; and
a signal-line driving circuit which is
used for supplying a positive-polarity signal voltage and a negative-polarity signal voltage to signal lines connected to said display cells in driving operations carried out in conformity with said polarity inversion driving method, and
provided with an output buffer section configured to amplify input data for driving said signal lines in order to generate said positive-polarity signal voltage as well as said negative-polarity signal voltage and selectively supplying said positive-polarity signal voltage as well as said negative-polarity signal voltage to a signal-line pair composing of a first one of said signal lines and a second one of said signal lines, wherein
said output buffer section employs
a positive-polarity operational transconductance amplifier configured to amplify said input data in order to generate said positive-polarity signal voltage,
a negative-polarity operational transconductance amplifier configured to amplify said input data in order to generate said negative-polarity signal voltage,
a first output section configured to supply said positive-polarity signal voltage or said negative-polarity signal voltage to said first signal line,
a second output section configured to supply said positive-polarity signal voltage or said negative-polarity signal voltage to said second signal line, and
a group of switches which are provided respectively on a forward path between the output node of said positive-polarity operational transconductance amplifier and an input node of said first output section, on a forward path between said output node of said positive-polarity operational transconductance amplifier and an input node of said second output section, on a forward path between the output node of said negative-polarity operational transconductance amplifier and another input node of said second output section, on a forward path between said output node of said negative-polarity operational transconductance amplifier and another input node of said first output section, on a feedback path between the output node of said first output section and a specific input node of said positive-polarity operational transconductance amplifier, on a feedback path between the output node of said second output section and said specific input node of said positive-polarity operational transconductance amplifier, on a feedback path between said output node of said second output section and a particular input node of said negative-polarity operational transconductance amplifier and on a feedback path between said output node of said first output section and said particular input node of said negative-polarity operational transconductance amplifier,
each of said first output section and said second output section carries out a process on said positive-polarity signal voltage generated by said positive-polarity operational transconductance amplifier and selectively supplied to said first and second output sections by said group of switches in a voltage range between a power-supply voltage and an intermediate reference voltage set between said power-supply voltage and a reference voltage, outputting a result of said process, and
each of said first output section and said second output section carries out another process on said negative-polarity signal voltage generated by said negative-polarity operational transconductance amplifier and selectively supplied to said first and second output sections by said group of switches in another voltage range between said reference voltage and an intermediate power-supply voltage set between said power-supply voltage and said reference voltage, outputting a result of said other process.

7. The display apparatus according to claim 6 wherein:
in a first mode, said group of switches
supplies said positive-polarity signal voltage generated by said positive-polarity operational transconductance amplifier to said first output section and feeds a signal output by said first output section back to said positive-polarity operational transconductance amplifier, and
supplies said negative-polarity signal voltage generated by said negative-polarity operational transconductance amplifier to said second output section and feeds a signal output by said second output section back to said negative-polarity operational transconductance amplifier; whereas
in a second mode, said group of switches
supplies said positive-polarity signal voltage generated by said positive-polarity operational transconductance amplifier to said second output section and feeds a signal output by said second output section back to said positive-polarity operational transconductance amplifier, and
supplies said negative-polarity signal voltage generated by said negative-polarity operational transconductance amplifier to said first output section and feeds a signal output by said first output section back to said negative-polarity operational transconductance amplifier.

8. The display apparatus according to claim 7 wherein:
said first output section includes
a first output amplifier operating in said voltage range between said power-supply voltage and said intermediate reference voltage set between said power-supply voltage and said reference voltage to serve as an output amplifier configured to amplify said positive-polarity signal voltage generated by said positive-polarity operational transconductance amplifier and selectively supplied to said first output section by said group of switches before outputting said positive-polarity signal voltage to said first signal line, and
a second output amplifier operating in said other voltage range between said reference voltage and said intermediate power-supply voltage set between said power-supply voltage and said reference voltage to serve as an output amplifier configured to amplify said negative-polarity signal voltage generated by said negative-polarity operational transconductance amplifier and selectively supplied to said first output section by said group of switches before outputting said negative-polarity signal voltage to said first signal line; whereas
said second output section includes
a third output amplifier operating in said other voltage range between said reference voltage and said intermediate power-supply voltage set between said power-supply voltage and said reference voltage to serve as an output amplifier configured to amplify said negative-polarity signal voltage generated by said negative-polarity operational transconductance amplifier and selectively supplied to said second output section by said group of switches before outputting said negative-polarity signal voltage to said second signal line, and
a fourth output amplifier operating in said voltage range between said power-supply voltage and said intermediate reference voltage set between said power-supply voltage and said reference voltage to serve as an output amplifier configured to amplify said positive-polarity signal voltage generated by said positive-polarity operational transconductance amplifier and selectively supplied to said second output section by said group of switches before outputting said positive-polarity signal voltage to said second signal line.

9. The display apparatus according to claim 8 wherein:
said first output section has a first input node and a second input node;
said second output section has a third input node and a fourth input node;
in said first mode,
said positive-polarity signal voltage generated by said positive-polarity operational transconductance amplifier is supplied to said first output amplifier of said first output section by way of said first input node, and
said negative-polarity signal voltage generated by said negative-polarity operational transconductance amplifier is supplied to said third output amplifier of said second output section by way of said third input node; whereas
in said second mode,
said positive-polarity signal voltage generated by said positive-polarity operational transconductance amplifier is supplied to said fourth output amplifier of said second output section by way of said fourth input node, and
said negative-polarity signal voltage generated by said negative-polarity operational transconductance amplifier is supplied to said second output amplifier of first second output section by way of said second input node.

10. The display apparatus according to claim 6 wherein the level of said intermediate reference voltage is about equal to the level of said intermediate power-supply voltage.

11. An electronic apparatus has a display apparatus comprising:
a display section on which display cells driven by adoption of a polarity inversion driving method are laid out to form a cell matrix; and
a signal-line driving circuit which is
used for supplying a positive-polarity signal voltage and a negative-polarity signal voltage to signal lines connected to said display cells in driving operations carried out in conformity with said polarity inversion driving method, and
provided with an output buffer section configured to amplify input data for driving said signal lines in order to generate said positive-polarity signal voltage as well as said negative-polarity signal voltage and selectively supplying said positive-polarity signal voltage as well as said negative-polarity signal voltage to a signal-line pair composing of a first one of said signal lines and a second one of said signal lines, wherein
said output buffer section employs
a positive-polarity operational transconductance amplifier configured to amplify said input data in order to generate said positive-polarity signal voltage,
a negative-polarity operational transconductance amplifier configured to amplify said input data in order to generate said negative-polarity signal voltage,
a first output section configured to supply said positive-polarity signal voltage or said negative-polarity signal voltage to said first signal line,
a second output section configured to supply said positive-polarity signal voltage or said negative-polarity signal voltage to said second signal line, and
a group of switches which are provided respectively on a forward path between the output node of said positive-polarity operational transconductance amplifier and an input node of said first output section, on a forward path between said output node of said positive-polarity operational transconductance amplifier and an input node of said second output section, on a forward path between the output node of said negative-polarity operational transconductance amplifier and another input node of said second output section, on a forward path between said output node of said negative-polarity operational transconductance amplifier and another input node of said first output section, on a feedback path between the output node of said first output section and a specific input node of said positive-polarity operational transconductance amplifier, on a feedback path between the output node of said second output section and said specific input node of said positive-polarity operational transconductance amplifier, on a feedback path between said output node of said second output section and a particular input node of said negative-polarity operational transconductance amplifier and on a feedback path between said output node of said first output section and said particular input node of said negative-polarity operational transconductance amplifier,
each of said first output section and said second output section carries out a process on said positive-polarity signal voltage generated by said positive-polarity operational transconductance amplifier and selectively supplied to said first and second output sections by said group of switches in a voltage range between a power-supply voltage and an intermediate reference voltage set between said power-supply voltage and a reference voltage, outputting a result of said process, and
each of said first output section and said second output section carries out another process on said negative-polarity signal voltage generated by said negative-polarity operational transconductance amplifier and selectively supplied to said first and second output sections by said group of switches in another voltage range between said reference voltage and an intermediate power-supply voltage set between said power-supply voltage and said reference voltage, outputting a result of said other process.

12. A signal-line driving circuit comprising output buffer means for amplifying input data for driving signal lines in order to generate a positive-polarity signal voltage as well as a negative-polarity signal voltage and selectively supplying said positive-polarity signal voltage as well as said negative-polarity signal voltage to a signal-line pair composing of a first one of said signal lines and a second one of said signal lines, wherein
said output buffer means employs:
a positive-polarity operational transconductance amplifier for amplifying said input data in order to generate said positive-polarity signal voltage;
a negative-polarity operational transconductance amplifier for amplifying said input data in order to generate said negative-polarity signal voltage;
first output means for supplying said positive-polarity signal voltage or said negative-polarity signal voltage to said first signal line;
second output means for supplying said positive-polarity signal voltage or said negative-polarity signal voltage to said second signal line; and
a group of switches which are provided respectively on a forward path between the output node of said positive-polarity operational transconductance amplifier and an input node of said first output means, on a forward path between said output node of said positive-polarity operational transconductance amplifier and an input node of said second output means, on a forward path between the output node of said negative-polarity operational transconductance amplifier and another input node of said second output means, on a forward path between said output node of said negative-polarity operational transconductance amplifier and another input node of said first output means, on a feedback path between the output node of said first output means and a specific input node of said positive-polarity operational transconductance amplifier, on a feedback path between the output node of said second output means and said specific input node of said positive-polarity operational transconductance amplifier, on a feedback path between said output node of said second output means and a particular input node of said negative-polarity operational transconductance amplifier and on a feedback path between said output node of said first output means and said particular input node of said negative-polarity operational transconductance amplifier,
each of said first output means and said second output means carries out a process on said positive-polarity signal voltage generated by said positive-polarity operational transconductance amplifier and selectively supplied to said first and second output means by said group of switches in a voltage range between a power-supply voltage and an intermediate reference voltage set between said power-supply voltage and a reference voltage, outputting a result of said process, and
each of said first output means and said second output means carries out another process on said negative-polarity signal voltage generated by said negative-polarity operational transconductance amplifier and selectively supplied to said first and second output means by said group of switches in another voltage range between said reference voltage and an intermediate power-supply voltage set between said power-supply voltage and said reference voltage, outputting a result of said other process.
